(19) United States
(12) Patent Application Publication
(10) Pub. No.: US 2008/0209645 A1
(43) Pub. Date: Sep. 4, 2008

(54) Surface Treatment Compositions Comprising Saccharide-Siloxane Copolymers

(75) Inventors: Fernando Vazquez Carrillo, Greensboro, NC (US); Michael Costello, Linwood, MI (US); Serge Firmin Alain Creutz, Liege (BE); Lorry Deklippel, Pont-A-Celles (BE); Benoit Henault, Waterloo (BE); Eric Jude Joffre, Midland, MI (US); Joseph Charles McAuliffe, Sunnyvale, CA (US); Virginia Kay O'Neil, Midland, MI (US); Christel Simon, Lobbes (BE)

Correspondence Address: DINSMORE & SHOHL LLP, ONE DAYTON CENTRE, ONE SOUTH MAIN STREET, SUITE 1300, DAYTON, OH, 45402-2023, US

(73) Assignees: DOW CORNING CORPORATION, Midland, MI (US); GENENCOR INTERNATIONAL, INC., Palo Alto, CA (US)

(21) Appl. No.: 11/915,007

(22) PCT Filed: May 23, 2006
(86) PCT No.: PCT/US06/20209

§ 371 Date: Apr. 2, 2008

Related U.S. Application Data
(60) Provisional application No. 60/683,589, filed on May 23, 2005.

(51) Int. Cl. D06M 15/643; C11D 1/00; C11D 17/00; C11D 17/04; C11D 3/37

(52) U.S. Cl. 8/137; 510/527; 510/516; 510/517; 252/8.91

(57) ABSTRACT

A surface treatment composition comprising at least one saccharide-siloxane copolymer having a saccharide component and an organosiloxane component and linked by a linking group, wherein the saccharide-siloxane copolymer has a specified formula and the surface treatment composition is adapted to provide at least one benefit to a surface to which it is applied, is provided. Dispersions and emulsions comprising the saccharide-siloxane copolymer, and treatment compositions comprising the emulsions and/or dispersions are also provided. The invention further provides methods and articles of manufacture comprising the inventive compositions.

Surface treatment compositions are described comprising saccharide-siloxane copolymers and modified and/or cross-linked saccharide-siloxane copolymers, articles of manufacture related thereto, and methods of use. Specific treatment compositions comprise fabric care compositions and applications thereof, in particular to impart improved fabric wrinkle resistance, softness, bulkiness and fast drying.

Saccharide-functional silicones, and processes for making them, are known in the art. For example, U.S. Pat. No. 4,591,652 describes methods for manufacturing polyhydroxyl silanes by reacting silanes having amine-terminated substituents with aldonic acid lactones. Japanese Patent No. 62-68820 discloses organopolysiloxanes comprising saccharide residues made from aminosiloxanes and saccharide lactones. WO 94/29324 describes siloxanyl-modified compounds, methods for their preparation and applications as surface-active and surface-modifying agents, particularly in the plant protection art. It more particularly discloses surface-active or surface-modifying agents formed from epoxy-trisiloxane reaction products and saccharide lactones. WO 02/088456 describes amido-functional aminopolydiorganosiloxanes, processes for the production thereof, preparations comprising the amido-functional aminopolydiorganosiloxanes and uses in the textile industry. The amido-functional siloxanes are formed from reacting aminosiloxanes and saccharide lactones.

Synthetic processes for linking saccharides and siloxanes are also known. For example, U.S. Pat. No. 5,831,080 describes organosilicone compounds containing glycoside radicals made by hydrosilylating allyl functional saccharide groups. U.S. Pat. No. 6,517,933 B1 describes a hybrid polymer material comprising a set of naturally occurring building blocks which include saccharides, and a set of synthetic building blocks which include polysiloxanes. A number of potential linking chemistries are described.

The above referenced patent art describes saccharide-functional siloxane copolymers which may be suitably used in the practice of the present invention. The patents are fully incorporated herein by reference. A person of ordinary skill in the art will readily appreciate, however, that a large variety of other saccharide-siloxane copolymers may be similarly employed.

The use of water-soluble saccharides is well known in the surface treatment arts. Water soluble polysaccharides, for instance, are ubiquitous ingredients in cleaning, sanitizing, polishing, toilet preparations, rug and upholstery shampoos, all purpose kitchen cleaners and disinfectants, toilet bowl cleaners, fabric softener-detergent combinations, fabric softeners, fabric sizing agents, dishwashing detergents, vehicle cleaners and the like. Widely used commercially available polysaccharides include water soluble polysaccharide ethers such as methyl cellulose (MC), hydroxypropylmethylcellulose (HPMC), hydroxyethylcellulose (HEC), hydroxypropylcellulose (HPC), ethylhydroxyethylcellulose (EHEC), hydroxypropyl (HP) guar, hydroxyethyl guar, guar, starch, and other nonionic starch and guar derivatives. The use of these prior art saccharides in such compositions is sometimes associated with difficulties such as compatibility with other ingredients, solubility with certain other ingredients, solution appearance and stability under alkaline (or acidic) conditions of the products. Delivery of the benefits conferred by these carbohydrates through functionalizing a hydrophobic siloxane component with the saccharides would ameliorate many of the processing issues.

Laundry detergent compositions, in particular, comprise a variety of active ingredients having particular functions, that may have unintended durability, quality and longevity effects. Such actives include but are not limited to surfactant systems, enzymes, bleaching agents, builder systems, suds suppressors, soil-suspending agents, soil-release agents, optical brighteners, dispersants, dye transfer inhibition compounds, abrasives, bactericides, and perfumes. Consumer desirability for fabric care and conditioning compositions has risen in conjunction with the rise in functional quality of detergents.

When consumers launder fabrics, they desire not only excellence in cleaning, they also seek to impart superior fabric care benefits. Such benefits can be exemplified by one or more of reduction of wrinkles benefits; removal of wrinkles benefits; prevention of wrinkles benefits; fabric softness benefits; fabric feel benefits; garment shape retention benefits; garment shape recovery benefits; elasticity benefits; ease of ironing benefits; perfume benefits; color care benefits; anti-abrasion benefits; anti-pilling benefits; or any combination thereof. Another desirable benefit would be to reduce the exposure of laundry to the drying cycle, since heated drying is well-known to hasten damage to and deterioration of fabric fibers. Compositions which provide both cleaning and fabric care benefits, e.g., fabric softening benefits, are known as “2 in 1”-detergent compositions and/or as “softening through the wash”-compositions.

Another development over the last couple of years relates to the means of providing and/or enhancing fabric care benefits in addition to fabric cleaning benefits. Nonlimiting examples of additional fabric care benefits include fabric softening benefits, wrinkle control benefits, and color care benefits. The common feature of these fabric care benefits is that a fabric care agent needs to be deposited on to a fabric. Certain wash and/or rinse conditions can impede deposition characteristics of such agents. In order to enhance the deposition characteristics of such fabric care agents, deposition aids have been added to such compositions. Examples of deposition aids suitable to enhance the deposition of fabric care agents are for example, cationic compounds, such as poly-quaternized ammonium compounds and cationic polysaccharides, e.g, cationic guar gums.

Patented technology directed to providing anti-wrinkling benefits to fabrics through the use of compositions comprising functionalized siloxanes is known. For example, U.S. Pat. No. 4,800,026 discloses anti-wrinkle benefits conferred by rinse cycle fabric softeners. Specifically, the '026 patentees assert that curable amine-functional linear or branched siloxanes formulated into a fabric softener will deposit and cure on the fabric, thus providing anti-wrinkle properties to the fabric.

More recently WO0125385 discloses a wrinkle recovery composition for fabric softener or dryer sheets which comprise a fabric softener, a polyethylene, a fatty alkanolamide, a polysilisic acid, a polyurethane and a dispersed amino or amido functionalized siloxane which also comprises a pendant ethoxylated, propoxylated or epoxy group.

EP 1075562 discloses a wrinkle control composition useful for spray applications. The compositions comprise an effective amount of wrinkle control agent selected from the group consisting of fiber lubricant, shape retention polymer and lithium salts and mixtures thereof. Wrinkle control agents may be D5-functionalized, polyoxyethylene-functionalized, and/or aminoglycol-functionalized siloxanes.

U.S. Pat. No. 6,001,343 discloses an odor absorbing and wrinkle controlling composition comprising essentially uncomplexed cyclodextrines and a wrinkle control fiber lubricant which is disclosed as a silicone oil. Siloxane in particular can be a D5-, Spe- or amino glycol-functionalized silicone. The compositions are applied via a spray mechanism and several types of spraying devices are disclosed.

EP 0791097 discloses, inter alia, a wrinkle-reducing composition which can be applied to fabrics. The composition comprises a wrinkle reducing agent which comprises an effective amount of silicone and an effective amount of a film-forming polymer. The compositions are disclosed as being essentially free of starch derivatives. In particular, the disclosed composition is adapted to impart a lubricating property or increased gliding ability to fibers in fabric, particularly clothing. The disclosed silicone may be an emulsified non-volatile PDMS, or an amino, reactive or non reactive, phenyl silicone.

EP1201817 discloses a composition for conferring wrinkle resistance comprising essentially a sterically hindered amino functionalized siloxane polymer where the active is delivered onto fabric via a laundry rinse cycle fabric softener, a wash-cycle detergent product, or via the ironing process.

Siloxane-functionalized polysaccharides are known ingredients in the household care art. For example, WO 03/050144 discloses antiwrinkle compositions comprising silicone polysaccharide compounds. The intended use is disclosed as providing anti-wrinkling benefits to cellulosic fiber containing fabric. However, this art is directed to compositions comprising siloxane functionalized and ionic functionalized polysaccharide polymers, and not saccharide functional and ionic functional siloxane polymers.

WO 03/20770 discloses a substituted polysaccharide comprising beta 1-4 linkages with at least one “deposition enhancing group” which undergoes a chemical change in water at operational temperature to increase the affinity of the substituted polysaccharide to a substrate. The substituted polysaccharide further comprises one or more independently selected silicone chains. Again, this art describes and discloses siloxane-functionalized polysaccharide polymers rather than saccharide-functionalized siloxanes.

WO 02/088456, published as US 2004/0186308 discloses amido-functional aminopolydiorganosiloxanes formed from the reaction of an aminosiloxane and gluconolactone in an emulsion. The reference discloses compositions comprising the compounds and teaches their usefulness for the finishing of inorganic fibers and textiles.

U.S. Pat. No. 6,307,000 discloses compositions relating to multifunctional nonionic and partially nonionic siloxane copolymers useful for binding to and modifying synthetic materials. More particularly, in the '000 patent the multifunctional nonionic and partially nonionic siloxane copolymers are durably bound to polyamide and polyester materials to simultaneously soften and enhance the hydrophilicity and thermal regulative properties of a fabric made from the synthetic materials. No polymerization between the siloxane copolymer and the synthetic materials is disclosed to take place during the modification process. In addition, the '000 patent requires that the ionic and nonionic functionality be located on different silicon atoms.

The present inventors surprisingly discovered that copolymers or cross-linked copolymers comprising saccharides covalently bound to siloxanes, when delivered in neat form or prepared as dispersions and incorporated into surface care compositions, impart enhanced benefits to the surface care treatment target substrates. In particular, when incorporated into fabric care compositions, the saccharide-siloxane copolymers improve wrinkle resistance, enhance softness and body, and decrease drying time in the target fabric substrates. These benefits were realized by consumers to a statistically significant degree in standardized consumer-based observation and manipulation tests.

Accordingly, one embodiment of the present invention provides a surface treatment composition. The surface treatment composition comprises: (i) at least one saccharide-siloxane copolymer having a saccharide component and an organosiloxane component and linked by a linking group. The saccharide-siloxane copolymer has the following formula:

R²ₐR¹₍₃₋ₐ₎)SiO—[(SiR²R¹O)ₘ—(SiR¹₂O)ₙ]_{y}—SiR¹₍₃₋ₐ₎R²ₐ
wherein each R¹ can be the same or different and comprises hydrogen, C₁-C₁₂ alkyl, an organic radical, or R³-Q,
Q comprises an epoxy, cycloepoxy, primary or secondary amino, ethylenediamine, carboxy, halogen, vinyl, allyl, anhydride, or mercapto functionality,
m and n are integers from 0 to 10,000 and may be the same or different, each a is independently 0, 1, 2, or 3,
y is an integer such that the copolymer has a molecular weight less than 1 million,
R² has the formula Z-(G¹)_{b}-(G²)_{c}, and there is at least one R² per copolymer, wherein G¹ is a saccharide component comprising 5 to 12 carbons,
b+c is 1-10, b or c can be 0,
G² is a saccharide component comprising 5 to 12 carbons additionally substituted with organic or organosilicon radicals,
Z is the linking group and is independently selected from the group consisting of:
   R³—NHC(O)—R⁴—;
   R³—NHC(O)O—R⁴—;
   R³—NH—C(O)—NH—R⁴—;
   R³—C(O)—O—R⁴—;
   R³—O—R⁴—;
   R³—CH(OH)—CH₂—O—R⁴—;
   R³—S—R⁴
   R³—CH(OH)—CH₂—NH—R⁴—; and
   R³—N(R¹)—R⁴, and
R³ and R⁴ are divalent spacer groups comprising (R⁵)ᵣ(R⁶)ₛ(R⁷)ₜ,
where at least one of r, s and t must be 1, and
R⁵ and R⁷ are either C₁-C₁₂ alkyl or ((C₁-C₁₂)O)ₚ where p is any integer 1-50 and each (C₁-C₁₂)O may be the same or different,
R⁶ is —N(R⁸)—, where R⁸ is H or C₁-C₁₂ alkyl, or is Z-X where Z is as previously defined or R³,
X is a carboxylic acid, phosphate, sulfate, sulfonate or quaternary ammonium radical, and at least one of R³ and R⁴ must be present in the linking group and may be the same or different,
and
wherein the saccharide-siloxane copolymer is a reaction product of a functionalized organosiloxane polymer and at least one hydroxy-functional saccharide such that the organosiloxane component is covalently linked via the linking group, Z, to the saccharide component, and wherein the surface treatment composition is adapted to provide at least one benefit to a surface to which it is applied.

The surface treatment composition may optionally comprise (ii) a carrier medium. In addition, the composition may optionally comprise (iii) a cross-linker. The cross-linker acts to cross-link among the saccharide-siloxane copolymers and/or with a substrate.

More specific embodiments of the surface treatment composition directed to various additional ingredients, benefits provided, specific carriers and specific surfaces to be treated are also provided. In further embodiments of the surface treatment compositions, more specific saccharide-siloxanes are provided as well. In additional embodiments the surface treatment compositions comprise the saccharide-siloxane copolymers in dispersed form, specifically as emulsions.

Another embodiment of the invention provides surface care products comprising the surface treatment compositions as described above. Specific embodiments are directed to fabric care products in varying forms providing particular benefits and comprising specified formulations of the treatment composition.

Further embodiments of the present invention are directed to articles of manufacture which comprise the surface treatment compositions as described above. One specific embodiment is directed to spray dispenser articles which may be either manually or non-manually operated. Other specific embodiments include dryer sheets.

Method embodiments are also provided. One such embodiment is directed to a method of treating a surface comprising administering an effective amount of the surface treatment compositions as described above. Particular embodiments are directed to methods of treating fabrics, including methods directed to providing specific fabric care benefits comprising applying an effective amount of the surface treatment compositions onto fabric using specified articles of manufacture. In certain aspects, the application may take place during one or more laundry cycles, wherein the laundry cycle may be a washing, a rinsing, or a drying cycle. Embodiments directed to methods for using the dryer sheets are also provided wherein it is understood that anti-wrinkling and softening benefits may be conferred to wet or already dried laundry.

These and additional embodiments and aspects of the present invention will be more fully appreciated by reference to the following detailed description of the preferred embodiments and examples provided below.

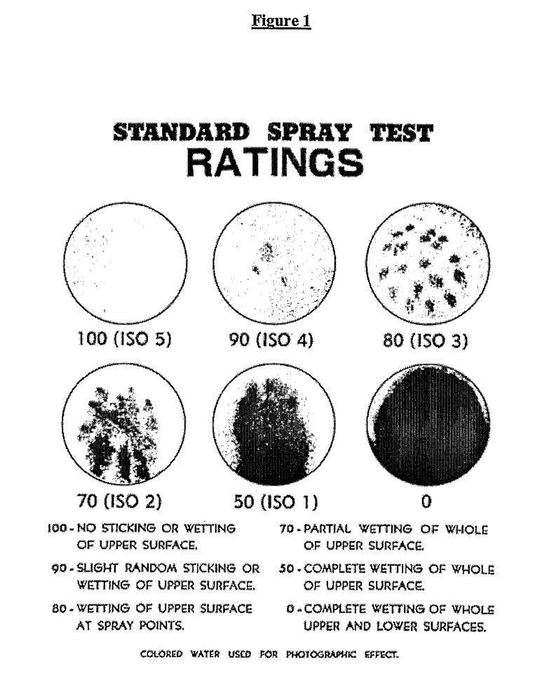

FIG. 1 is a Comparison Chart for AATCC Test Method 22-2001 for Water Repellency.

The present inventors surprisingly discovered that adding copolymers of saccharide-functionalized siloxanes to surface treatment formulations resulted in several improved performance benefits to the treated surface. The copolymers may be added in neat form, as dispersions including emulsions, or in conjunction with crosslinking agents wherein they are included as cross-linked networks. The copolymers confer advantages to the surface care treatment compositions based on the polymer property changes due to increased hydrogen bonding, surface active properties, and their substantivity to polyhydroxy substrates.

Embodiment of the present invention relate generally to surface treatment compositions, methods, and related articles of manufacture comprised thereof. Although in many specified embodiments and examples the compositions, methods and articles are adapted and suitable for household care applications, e.g. fabric care, dishwashing, and hard surface cleansing, it will be apparent to one of ordinary skill in the art that the surface treatment compositions may also be useful in a variety of industries such as industrial, automotive or marine vehicle care, or in any application where surfaces or areas exist that are in need of treatment including, for example, cleansing, waxing, conditioning, disinfecting, and UV screening. Surfaces which may be benefited include but are not limited to: hard surfaces such as metal, porcelain, glass and ceramics generally, some plastics, hard-coated surfaces, and the like; porous surfaces such as wood, cement, tile, plaster, hardened clays, some plastics and foam products and the like, flexible surfaces such as leather, natural and man-made, woven and nonwoven fiber-based products such as carpets and fabrics, flat-painted surfaces, and the like. The surface treatment compositions may be formulated to provide multiple benefits in one application to the substrate intended to be treated. For example, an applicator such as a spray bottle or impregnated porous material (e.g. a wipe) may comprise a single composition formulated to provide cleansing, disinfecting and fast-drying benefits. Or a single composition may be formulated to provide cleansing, enhanced luster and enhanced smoothness benefits.

One embodiment of the present invention provides a surface treatment composition. The surface treatment composition comprises: (i) at least one saccharide-siloxane copolymer having a saccharide component and an organosiloxane component and linked by a linking group, wherein the saccharide-siloxane copolymer has the following formula:

R²ₐR¹₍₃₋ₐ₎SiO—[(SiR²R¹O)ₘ—(SiR¹₂O)ₙ]_{y}—SiR¹₍₃₋ₐ₎R²ₐ
wherein each R¹ can be the same or different and comprises hydrogen, C₁-C₁₂ alkyl, an organic radical, or R³-Q,
Q comprises an epoxy, cycloepoxy, primary or secondary amino, ethylenediamine, carboxy, halogen, vinyl, allyl, anhydride, or mercapto functionality,
m and n are integers from 0 to 10,000 and may be the same or different, each a is independently 0, 1, 2, or 3,
y is an integer such that the copolymer has a molecular weight less than 1 million,
R² has the formula Z-(G¹)_{b}-(G²)_{c}, and there is at least one R² per copolymer, wherein G¹ is a saccharide component comprising 5 to 12 carbons,
b+c is 1-10, b or c can be 0,
G² is a saccharide component comprising 5 to 12 carbons additionally substituted with organic or organosilicon radicals,
Z is the linking group and is independently selected from the group consisting of:
   R³—NHC(O)—R⁴—;
   R³—NHC(O)O—R⁴—;
   R³—NH—C(O)—NH—R⁴—;
   R³—C(O)—O—R⁴—;
   R³—O—R⁴—;
   R³—CH(OH)—CH₂—O—R⁴—;
   R³—S—R⁴
   R³—CH(OH)—CH₂—NH—R⁴—; and
   R³—N(R¹)—R⁴, and
R³ and R⁴ are divalent spacer groups comprising (R⁵)ᵣ(R⁶)ₛ(R⁷)ₜ,
where at least one of r, s and t must be 1, and
R⁵ and R⁷ are either C₁-C₁₂ alkyl or ((C₁-C₁₂)O)ₚ where p is any integer 1-50 and each (C₁-C₁₂)O may be the same or different,
R⁶ is —N(R⁸)—, where R⁸ is H or C₁-C₁₂ alkyl, or is Z-X where Z is previously defined or R³,
X is a carboxylic acid, phosphate, sulfate, sulfonate or quaternary ammonium radical, and at least one of R³ and R⁴ must be present in the linking group and may be the same or different,
and
wherein the saccharide-siloxane copolymer is a reaction product of a functionalized organosiloxane polymer and at least one hydroxy-functional saccharide such that the organosiloxane component is covalently linked via the linking group, Z, to the saccharide component;
and wherein surface treatment composition is adapted to provide at least one benefit to a surface to which it is applied.

The surface treatment composition may optionally comprise (ii) a carrier medium; and/or (iii) a cross-linker.

Cross-linkers suitable for use in practicing the present invention are well known in the art. In specific embodiments the crosslinking substantially occurs between the hydroxyl-functional groups of the saccharide components and/or with the substrates. In more specific embodiments the cross-linker may be selected from the following non-limiting list: boric acid, borate ester (e.g. tri-n-propyl borate, triisopropanolamine borate), alkyl boronic acid or ester (e.g. phenyl boronic acid), titanate, (e.g. titanium isopropoxide, diisopropoxytitanium bis(acetylacetonate)), zirconate, glyoxal, gluteraldehyde, epichlorohydrin, urea-formaldehyde, zirconium ammonium carbonate, salt of a multivalent ion, bifunctional epoxy or glycidyl compounds (e.g. 1,4 butanediol diglycidyl ether), di-(N-hydroxymethyl)urea, diisocyanate (e.g. toluene diisocyante, hexamethylene diisocyanate), 2-chloro N,N diethylacetamide, sodium trimetaphosphate, phosphorous oxychloride, acrolein, N-methyl urea, dicarboxylic acid, bis-acid chloride, dialkyldichlorosilane (e.g. dimethyldichlorosilane), alkyltrichlorosilane (e.g. Methyltrichlorosilane), reactive siloxane resin, and combinations thereof. In a very specific embodiment, the cross-linker comprises a reactive siloxane resin or boronic acid or ester.

Embodiments are provided wherein the surface treatment composition further comprises a surfactant. The surfactant is present at a level of from about 0.05% to about 99%, by weight of the composition; and is selected from one of the following: nonionic surfactant; anionic surfactant; cationic surfactant; amphoteric surfactant; or mixtures thereof. In another specific embodiment of the surface treatment composition, the at least one benefit comprises color retention, anti-abrasion, anti-pilling, reduced drying time, water absorbency, gloss, lubrication, protection, friction modification, stain resistance, water repellency, abrasion resistance, color-permeability, reduction of wrinkles, prevention of wrinkles, removal of wrinkles, fabric softening, fabric feel enhancement, garment shape retention, elasticity, ease of ironing or any combination thereof, to surfaces.

Other specific embodiments provide surface treatment compositions further comprising at least one adjunct ingredient. The adjunct ingredient is selected from the group consisting essentially of bleaches, emulsifiers, fabric softeners, perfumes, antibacterial agents, antistatic agents, brighteners, dye fixative agents, dye abrasion inhibitors, anti-crocking agents, wrinkle reduction agents, wrinkle resistance agents, shape retention agents, soil release agents, sunscreen agents, anti-fade agents, waterproofing agents, drying agents, stain-proofing agents, soil repelling agents, odor control agents, foam control agents, insect-repelling agents, enzymes, protective agents, anti-corrosive agents, detersive agents, builders, structurants, thickeners, pigments or dyes, viscosity modifiers, pH control agents, propellants and combinations thereof. Ingredients which are customary for specific surface treatment compositions directed to hard surface substrates include, but are not limited to: acids or bases or pH buffering agents, inorganic builders, organic co-builders, surfactants, polymeric color transfer inhibitors, polymeric anti-redeposition agents, soil release polymers, enzymes, complexing agents, corrosion inhibitors, waxes, other thickeners, foam modulating agents, additional silicone oils, UV or other radiation protection agents, dyes, solvents, hydrotropic agents, bleaching agents, cloud point modifiers, preservatives, and mixtures thereof.

Some embodiments of the present invention comprise an aqueous liquid carrier that includes water and optionally one or more organic solvents. Other carriers suitable for a particular embodiment are contemplated as being within the scope of the surface treatment compositions. Propellants, woven and non-woven fibrous and/or absorbant substrates, solids, Zeolites, and cyclodextrins are all well known in the art and may form suitable carriers. When solids form the carrier agent they may be encapsulated or granulated, according to suitability for any particular application.

The surfaces to which the surface treatment compositions may be applied surface which may benefit from those surface treatment compositions or methods. The shape of the surface is immaterial and it may have a planar, complex, or irregular contour. The surface may be hard, rigid, semi-rigid, porous, transparent, flexible, or combinations thereof. A “hard surface” is any surface which is traditionally regarded as hard, that is ceramic, glass, metallic, enamel, or plastic, for example, and may be formed into tableware, such as plates, glasses, cutlery, pots and pans, and other household surfaces such as kitchen counter tops, sinks, glass, windows, enamel surfaces, metal surfaces, tiles, bathtubs, floors etc. In one specific embodiment the hard surface is tableware. Hard surfaces typically do not include fabrics, such as clothing, curtains or the like. Porous surfaces include, for example, some woods, cement, some polymeric coatings, polymeric foams, and bricks formed from clay or stone. Flexible surfaces include, for example, less rigid plastics, leather and any natural or manmade textile and the substrates manufactured therefrom, including fabric. Also included are natural and manmade fibrous materials in woven and nonwoven form. These may take the form of washable clothes, washable shoes, dry cleanable clothes, linens, towels, draperies, window curtains, shower curtains, table linens, and any portion thereof. Also included are carpets.

Saccharide-functional silicones, and processes for making them, are known in the art. For example, U.S. Pat. No. 4,591,652 describes methods for manufacturing polyhydroxyl silanes by reacting silanes having amine-terminated substituents with aldonic acid lactones. Japanese Patent No. 62-68820 discloses organopolysiloxanes comprising saccharide residues made from aminosiloxanes and saccharide lactones. WO 94/29324 describes siloxanyl-modified compounds, including surface-active or surface-modifying agents formed from epoxy-trisiloxane reaction products and saccharide lactones and methods for their preparation. WO 02/088456 describes amido-functional aminopolydiorganosiloxanes formed from reacting aminosiloxanes and saccharide lactones.

Synthetic processes for linking saccharides and siloxanes are also known in the art. For example, U.S. Pat. No. 5,831,080 describes organosilicone compounds containing glycoside radicals made by hydrosilylating allyl functional saccharide groups. U.S. Pat. No. 6,517,933 B1 describes a hybrid polymer material comprising a set of naturally occurring building blocks which include saccharides, and a set of synthetic building blocks which include polysiloxanes. A number of potential linking chemistries are described. The complete disclosures of the aforementioned patent art references are fully incorporated herein by reference. Additionally the saccharide siloxanes can be modified by further reaction of anionic or cationic monomers to functional sites on the sugar siloxane.

In one embodiment of the surface treatment composition, at least one of the hydroxyl-functional saccharides comprises an aldonic acid or an oligoaldonic acid. In a more specific embodiment the aldonic acid or the oligoaldonic acid comprises a lactone. Two exemplary lactones include gluconolactone (GL) and lactobionolactone (LBL). Both gluconolactone (GL) and lactobionolactone (LBL) are commercially available. While GL and LBL are readily commercially available saccharides, one of ordinary skill in the art will appreciate that other saccharides are suitable for forming copolymers with siloxanes.

In specific embodiments of the surface treatment composition, the organosiloxane polymer comprises a polydimethylsiloxane. In some embodiments the linking group comprises an amide, an amino, a urethane, a urea, an ester, an ether, a thioether, or an acetal functional linking group. In more specific embodiments the linking group comprises an amino functional linking group, and in very specific embodiments the amino functional linking group comprises aminopropyl or aminoethylaminoisobutyl functional groups.

Aldonolactones are particularly suitable saccharides when the organosiloxane comprises amino-functionality and in very specific embodiments the saccharide-siloxane copolymer comprises the reaction product of an amino-functional organosiloxane and a lactone. Hence, in even more specific embodiments, the saccharide-siloxane copolymer comprises the reaction product of an amino-functional organosiloxane and an aldonolactone such as GL or LBL.

In a specific embodiment of the inventive surface treatment composition, the at least one hydroxy-functional saccharide comprises an aldonic acid or an oligoaldonic acid. In a more specific embodiment, the aldonic acid or the oligoaldonic acid comprises a lactone, and in a very specific embodiment the lactone comprises gluconolactone or lactobionolactone.

In a further specific embodiment of the surface treatment composition, the functionalized organosiloxane polymer comprises a polydimethylsiloxane. Further embodiments are directed to the surface treatment composition wherein the linking group comprises an amide, an amino, a urethane, a urea, an ester, an ether, a thioether, or an acetyl functional linking group. In specific embodiments the linking group comprises an amino functional linking group. In very specific embodiments, the amino functional linking group comprises aminopropyl or aminoethylaminoisobutyl functional groups.

The saccharide-siloxane copolymers may be formulated into the surface treatment compositions in a substantially pure form, or as dispersions, in the form of either simple dilutions or emulsions. In the case of some aqueous-based formulations the saccharide-siloxane may be added directly to the formulation as a solid.

The saccharide-siloxane copolymer components typically exist as gums, waxy solids or solids at ambient conditions. It should be noted, however, that there is a small subset of the copolymer that does exist in a liquid form, and liquid dispersible forms may also be produced by manipulating conditions such as temperature. However, in order for most of the saccharide-siloxane copolymers to achieve a viscosity range that permits ready formation of dispersions, for example solutions or emulsions, they must first be solubilized by being dissolved in a suitable solvent or solvent blend.

The solubilized copolymer is then used to form a solution or emulsion for ready delivery into the surface treatment composition. The particular solvent blend is selected based upon the ionic properties of the saccharide-siloxane copolymer, and the suitability of that solvent for the intended application. In one specific embodiment the solvent blend comprises a mixture of paraffin and an alcohol. In a very specific embodiment the alcohol comprises isopropyl alcohol.

The term “dispersion” as used herein means a two-phase system where a first phase comprises finally divided particles distributed throughout a bulk second phase and the first phase constitutes an “internal” or dispersed phase while the second phase constitutes an “external” or continuous phase.

The term “solution” as used herein is intended broadly to include mechanical dispersions, colloidal dispersions and true solutions, and should not be construed as limited to the latter. A solution is a dispersion comprising a uniformly dispersed mixture wherein a first phase constitutes the solute and a second phase constitutes the solvent.

The term “emulsion” as used herein means a dispersion comprising a mixture of two immiscible liquids with the liquid constituting the first, dispersed internal phase being suspended in the second, continuous phase with the aid of an emulsifier.

In one embodiment of the surface treatment composition the dispersion is in the form of a simple dilution or a solution. The solvent may be substantially aqueous or substantially non-aqueous depending on the nature of the particular saccharide-siloxane selected. In a specific embodiment, the substantially nonaqueous solvent comprises a volatile or non-volatile solvent, and in a very specific embodiment the substantially nonaqueous solvent comprises a volatile hydrocarbon or a silicone or mixtures thereof. In a more specific embodiment the substantially nonaqueous solvent comprises a silicone.

The term “volatile” as used herein means that the solvent exhibits a significant vapor pressure at ambient conditions. Examples of suitable volatile silicones include siloxanes such as phenyl pentamethyl disiloxane, phenylethylpenamethyl disiloxane, hexamethyldisiloxane, methoxy propylheptamethyl cyclotetrasiloxane, chloropropyl pentamethyl disiloxane, hydroxypropyl pentamethyl disiloxane, octamethyl cyclotetrasiloxane, decamethyl cyclopentasiloxane and mixtures thereof. Particularly suitable silicones are the cyclomethicones. In a very specific embodiment the volatile silicone comprises a cyclic siloxane.

In some embodiments of the present invention the saccharide-siloxane component can be produced in particulate form, which may be preferred for blending with a solid cleaning product such as a powder detergent. An emulsion as described above can be deposited on a particulate solid carrier or can be spray dried. Examples of suitable solid carriers include soda ash (sodium carbonate), zeolites and other aluminosilicates or silicates, for example magnesium silicate, phosphates, for example powdered or granular sodium tripolyphosphate, sodium sulphate, sodium carbonate, sodium perborate, cellulose derivatives such as sodium carboxymethylcellulose, granulated or native starch and clay.

The saccharide-siloxane copolymer is typically solubilized. The solubilized copolymer is then used to form a solution or emulsion for ready delivery into the surface treatment compositions. The particular solvent blend is selected based upon the ionic properties of the saccharide-siloxane copolymer, and the suitability of that solvent for the intended application. In one specific embodiment the solvent blend comprises a mixture of paraffin and an alcohol. In a very specific embodiment the alcohol comprises isopropyl alcohol.

Because the saccharide-siloxane copolymer component is typically added to the surface treatment composition formulations as a dispersion, one may describe its concentration with respect to either the dispersion component or the surface treatment composition as a whole. In one embodiment wherein the surface treatment composition comprises a dispersion, the dispersion comprises from about 0.1% to about 50% saccharide-siloxane by weight percent and from about 0.01% to about 25% saccharide-siloxane by weight percent of the composition. In a more specific embodiment the dispersion comprises from about 2% to about 40% saccharide-siloxane by weight percent and from about 0.2% to about 10% saccharide-siloxane by weight percent of the composition. In an even more specific embodiment the solution comprises about 20% saccharide-siloxane by weight percent and about 0.5 to about 2% saccharide siloxane by weight of the composition.

In one embodiment of the surface treatment composition, the dispersion is in the form of an emulsion. The emulsion additionally comprises at least one surfactant to maintain the dispersion, and water as the continuous phase. The internal phase comprises the dispersed solubilized saccharide-siloxane copolymer. Nonionic, amphoteric (including zwitterionic), anionic or cationic surfactants may all be suitable. Oil in water emulsions are typically used because they are easier to handle and disperse readily into water-based formulations.

An additional embodiment of the present invention is directed to a saccharide-siloxane emulsion. The emulsion is an oil in water emulsion comprising an internal phase comprising the saccharide-siloxane and a continuous phase comprising water. The saccharide-siloxane emulsion comprises at least one surfactant which maintains the dispersion of the internal phase due to its amphipathic character.

It will be understood by one of ordinary skill in the art that there is a continuum for the ease with which a desired emulsion forms. Saccharide-siloxane emulsions share similar constraints with other emulsions. That is, they are thermodynamically unstable, require a surfactant to maintain the dispersion, and need an input of energy to initiate emulsification. Simple agitation via mixing may be sufficient, or higher shear means including the employment of high shear devices may be required. In other instances, a polymer emulsification or inversion method is needed.

A degree of agitation necessary to form the emulsion may require employment of mixing devices. Mixing devices typically provide the required energy input. Non-limiting examples of these mixing devices spanning the shear range include: 1) a vessel with an impeller, for example, propeller, pitched blade impeller, straight blade impeller, Rushton impeller, or Cowles blade; 2) kneading type mixers, for example, Baker-Perkins; 3) high shear devices which use positive displacement through an orifice to generate shear, for example, homogenizer, sonolater, or microfluidizer; 4) high shear devices using a rotor and stator configuration, for example, colloid mills, homomic line mills, IKA, or Bematek; 5) continuous compounders with single or dual screws; 6) change can mixers with internal impellers or rotor/stator devices, for example, Turello mixer; and 7) centrifugal mixers, for example, Hauschild speedmixers. Combinations of mixing devices can also provide benefits, for example a vessel with an impeller can be connected to a high shear device.

The choice of mixing device is based on the type of internal phase to be emulsified. For example, low viscosity internal phases can be emulsified using high shear devices which use positive displacement through an orifice. However, in the case of high viscosity internal phases, a rotor/stator device, twin screw compounder or change can mixer are often better choices. In addition, internal phases that contain hydrophilic groups are often easier to emulsify and therefore a simple vessel configured with an impeller may be sufficient.

The viscosity of the saccharide-siloxane copolymers is dependent on such factors as the molecular weight of the siloxane portion, the number of saccharide units, the mole percent of saccharide units per siloxane, and the external conditions such as temperature and pressure. One skilled in the art would recognize that variable internal phase viscosities may be achieved by varying proportions in blends of saccharide-siloxane copolymers with solvents or solvent mixtures.

The most desirable order of ingredient addition in the preparation of the emulsion is determined empirically. For example, a desirable order of addition for a thick-phase emulsification may be: (a) solubilize the saccharide-siloxane copolymer in a solvent or solvent blend to a desired viscosity; (b) blend in a surfactant; (c) add water in increments with shear until a thick phase emulsion forms; (d) dilute with water to desired concentration, with shear. A desirable order of addition for a “pre-mix” with high shear may be: (a) add all the water to a mixing vessel configured with an impeller; (b) blend at least one surfactant with the water; (c) slowly add the saccharide-siloxane copolymer phase to the water to make a rough emulsion; (d) convey the rough emulsion through a high shear device until a desired particle size is achieved.

Nonionic surfactants are suitable for making the emulsions and include alkyl ethoxylates, alcohol ethoxylates, alkylphenol ethoxylates, glyceryl esters, and mixtures thereof. Cationic, amphoteric and/or anion surfactants are also suitable and are typically added in addition to a nonionic surfactant. In a specific embodiment the emulsion comprises at least one nonionic surfactant and in another specific embodiment the emulsion comprises at least one cationic surfactant and at least one nonionic surfactant.

In one embodiment of the surface treatment composition wherein the saccharide-siloxane is delivered to the composition in the form of an emulsion, the emulsion comprises from about 5% to about 95% saccharide-siloxane by weight percent of the emulsion and the composition comprises from about 0.01% to about 25% saccharide-siloxane by weight percent of the composition. In a more specific embodiment the emulsion comprises from about 10% to about 60% saccharide-siloxane by weight percent of the emulsion and from about 0.2% to about 10% saccharide-siloxane by weight percent of the composition. In an even more specific embodiment the solution comprises about 20-40% saccharide-siloxane by weight percent and about 0.5 to about 2% saccharide siloxane by weight of the composition.

An additional embodiment is directed to an emulsion comprising an internal phase which comprises at least one of the saccharide-siloxane copolymers as formulaically disclosed above. In this embodiment the dispersion of the internal phase is maintained by a surfactant and the continuous phase is water. The emulsion may be further diluted with water to provide a concentration of actives suitable for a particular surface treatment application.

A further embodiment provides methods for preparing such emulsions. Various degrees of agitation may be employed to achieve emulsions with properties desirable for particularly intended applications. In an even more specific embodiment, emulsion polymerization is employed whereby the saccharide-siloxane monomers are polymerized into higher molecular weight polymers within each micelle of the emulsion.

In one embodiment, the surface is a fabric and the surface treatment composition is operational as a fabric treatment composition. In specific embodiments the fabric treatment composition is provided as a laundry detergent additive, a pre-laundering treatment, a rinse-added treatment, a post laundering-treatment, soaking treatment, rinsing treatment, spray-on treatment or drying treatment formulation.

Also contemplated as within the scope of the present invention are surface care products comprising the surface care treatment compositions. A specific embodiment provides a fabric care product comprising fabric treatment compositions formulated according to the present invention. In a more specific embodiment the fabric care product is provided as a detergent, a detergent adjunct, a rinse, a rinse adjunct, a pre-wash soak, a post-wash soak, a spray-on, or a dryer sheet. As used herein, the term “dryer sheet” is meant to encompass woven and nonwoven substrates which may be impregnated with the compositions and added to the dry cycle of a conventional laundering process which may include a pre-wash, wash, rinse, and dry cycles. Typically the dry cycle takes place in a “dryer,” which is a machine designed to air-dry laundered garments via some combination of tumbling and circulation of air. The dryer sheet may be either a wet or dry-formulated dryer sheet and is typically discarded after use.

Embodiments are also provided wherein the fabric care product provides one or more benefits selected from the group consisting of reduction of wrinkles, prevention of wrinkles, removal of wrinkles, fabric softening, fabric feel enhancement, garment shape retention, elasticity, ease of ironing, color retention, anti-abrasion, anti-pilling, reduced drying time, and any combination thereof, to fabrics. In a specific embodiment the fabric care product is provided in the form of a rinse adjunct, wherein the rinse adjunct is delivered to the fabric during a rinse cycle. In another specific embodiment, the fabric care product is provided in the form of a detergent. Where the intended use of the fabric care product is during either the washing or rinsing cycles, the fabric care product may be provided as a liquid or a dissolvable solid.

When formulated as detergent products, the surface treatment compositions comprise as one essential component at least one surfactant selected from the group consisting of anionic surfactants, zwitterionic surfactants, amphoteric surfactants, nonionic surfactants, cationic surfactants, and mixtures thereof. By nature, any surfactant known in the art of detergent compositions may be used, such as disclosed in (1) “Surfactant Science Series”, Vol. 7, edited by W. M. Linfield, Marcel Dekker and in (2) “Surface—Active Agents & Detergents”, Volumes I and II, by Schwatz, Perry and Berch. Suitable levels of this component are in the range from 1.0% to 80%, preferably from 5.0% to 65%, more preferably from 10% to 50% by weight of the composition.

As detergents, embodiments according to the present surface treatment compositions may be formulated as powder detergents, tablet detergents, liquid detergents as well as softergent without respect to the means of delivery.

As a fabric care detergent product embodiment, the saccharide-siloxane copolymer comprises from about 0.01% to about 30% by weight of the detergent and the fabric treatment composition further comprises from about 2.0% to about 80% by weight, of a surfactant system. In a specific embodiment, the fabric treatment composition further comprises at least one compound selected from the group consisting of liquid carriers; builders; suds suppressors; stabilizers; perfumes; chelating agents; colors; opacifiers; anti-oxidants; bactericides; neutralizing agents; buffering agents; phase regulants; dye-transfer inhibitors; hydrotropes; thickeners; perfumes; bleaches; bleach activators; bleach catalysts; optical brighteners; soil release actives; photoactivators; preservatives; biocides; fungicides; color speckles; colored beads; spheres or extrudates; sunscreens; fluorinated compounds; pearlescent agents; luminescent agents or chemi-luminescent agents; anti-corrosion and/or appliance protectant agents; alkalinity sources or other pH adjusting agents; solubilizing agents; processing aids; pigments; free radical scavengers; pH control agents; and mixtures thereof.

Embodiments of the present invention are also directed to articles of manufacture comprising the surface treatment compositions. Typically, the articles are designed to dispense the compositions. In one embodiment the article of manufacture comprises a spray dispenser. A specific embodiment is directed to a trigger spray dispenser. Another embodiment provides a non-manually operated sprayer. A further article embodiment is directed to a wet or dry dryer sheet, and a specific embodiment provides a dry dryer sheet. One article embodiment is directed to a disposable wipe impregnated with the surface treatment compositions. A consumer may use the wipe by applying it directly to the surface in need of treatment. The wipe may be pre-moistened or may be dry requiring the consumer to wet the wipe prior to application. For some surfaces a cleaning or scouring pad impregnated with the surface treatment compositions may be desirable. It is further contemplated that disposable cleaning pads may attach to a handle, such as a mop handle, so that the consumer may either reach inconveniently placed surfaces with greater ease, or be able to apply the treatment compositions to surfaces in need of treatment without directly handling the compositions.

Method embodiments are also provided. On such embodiment is directed to a method of treating a surface comprising administering an effective amount of the surface treatment compositions to a surface. A method of cleaning surfaces is also provided, comprising the step of wiping the surface by contacting the surface with a cleaning tool selected from the group consisting of sponges, cloths, cellulose strings, cellulose strips, paper, paper towels, pre-moistened wipe laminates and absorbent disposable cleaning pads. Another embodiment provides a method of treating a fabric comprising administering an effective amount of the inventive fabric treatment compositions.

In one specific embodiment, a method of preventing or reducing wrinkles on fabric is provided that comprises spraying an effective amount of the fabric treatment composition onto a fabric using a spray dispenser. In more specific embodiments the spray dispenser is a trigger spray dispenser, while in other specific embodiments the spray dispenser is a non-manually operated sprayer. In very specific embodiments the non-manually operated sprayer is selected from the group consisting of: powered sprayers, air aspirated sprayers, liquid aspirated sprayers, electrostatic sprayers, and nebulizer sprayers.

Another embodiment is directed to a method of providing a fabric softening and/or anti-wrinkling benefit to fabrics during a laundry cycle, wherein the laundry cycle may be a washing, a rinsing, or a drying cycle. The method comprises the steps of: (a) contacting the fabric, during the laundry cycle, with the fabric treatment composition formulated according to embodiments of the present invention.

Additional embodiments include methods for using the dryer sheets to provide a softening and/or anti-wrinkling benefit to laundry. The method comprises the steps of: providing an air-dryer and a quantity of wet or dry wrinkled laundry; placing the wrinkled laundry inside the air-dryer; placing one of the dryer sheets inside the air dryer; operating the air-dryer for a period of time sufficient to provide the softening and/or wrinkling benefit; removing the laundry and dryer sheet from the air dryer; and discarding the dryer sheet. The laundry in need of the softening and/or anti-wrinkling benefit is not limited to that which has just undergone a laundering process. The air-dryer in combination with the dry sheets may be used to soften and/or diminish wrinkling in any fabric, wet or dry, in need of softening and/or de-wrinkling benefits.

Another embodiment provides a method of decreasing drying time of a fabric undergoing a laundering process and providing an antistatic, anti-pilling and/or anti-abrasion benefit to the fabric. The method comprises: contacting the fabric with the fabric treatment composition prior to or during the laundering process.

Particular embodiments of the present compositions and applications are resented in the following examples. These examples are for purposes of illustration only and should not be construed to limit the scope of the invention as defined by the claims. Other variants and embodiments within the scope of the invention will be readily apparent to those of ordinary skill in the surface treatment arts.

### EXAMPLES

The examples below provide methods for preparing the saccharide-siloxane copolymer component in several delivery forms and the specific saccharide-siloxane copolymers synthesized thereby. Of course, it will be readily appreciated by a person of ordinary skill in the art that there are alternative methods of synthesis and a wide range of saccharide-siloxane copolymers which may be synthesized and suitably employed according to embodiments of the present invention. Additional examples are directed to specific household care product embodiments and are illustrative in nature. The specificity of the exemplar embodiments is for convenience and should not be taken as limiting.

### Example 1

### Preparation of Suitable Saccharide-Siloxane Copolymers

This example illustrates saccharide-siloxane copolymers which may be suitably employed in embodiments as household care compositions, related methods and applications thereof. The components of exemplary saccharide siloxanes are disclosed in Table 1. Properties of exemplary suitable siloxanes are disclosed in Table 2.

TABLE 1
Saccharide-Siloxane Copolymer Descriptions

| Siloxane | Saccharide | Functionality:Saccharide | Solvent |
|---|---|---|---|
| A12 | GL | 1:1 | water |
| A21 | GL | 1:1 | heptane, cyclics |
| A32 | GL | 1:1 | heptane, cyclics |
| 8175 | GL | 1:1 | heptane, cyclics |
| 8211 | GL | 1:1 | heptane, cyclics |
| 8175/A12 | GL | 1:1 | dispersion in |
| | | | heptane, cyclics |
| A12 | LBL | 1:1 | dispersion in |
| | | | water |
| A21 | LBL | 1:1 | heptane, cyclics |
| A32 | LBL | 1:1 | heptane, cyclics |
| 8175 | LBL | 1:1 | heptane, cyclics |
| 8211 | LBL | 1:1 | heptane, cyclics |
| 8175/A12 | LBL | 1:1 | |

TABLE 2
Aminofunctional Polymers Employed

| | | | | DP | | functional |
|---|---|---|---|---|---|---|
| polymer | cst | MW | % NH2 | theory | mpc F | group |
| DMS- | 20-30 | 950 | 3.1 | 12 | | aminopropyl |
| A12 | | | | | | |
| DMS- | 100-120 | 5000 | 0.65 | 66 | | aminopropyl |
| A21 | | | | | | |
| DMS- | 2000 | 27000 | 0.085 | 363 | | aminopropyl |
| A32 | | | | | | |
| 2-8175 | 150-400 | 7800 | | 100 | 2.3 | isobutyl- |
| | | | | | | ethylene- |
| | | | | | | diamine |
| 2-8211 | 1000 | 23000 | | 300 | 1.9 | isobutyl- |
| | | | | | | ethylene- |
| | | | | | | diamine |

Abbreviations:
cst—Centistoke;
MW—molecular weight;
DP—Degree of polymerization;
mpcF—mole percent functionality

### a) A12-GL

DMS-A12 (Gelest Inc., Morrisville, Pa.), a 20-30 cst. telechelic polydimethylsiloxane endblocked with aminopropyl groups, is reacted with gluconolactone (GL) (Sigma-Aldrich, St. Louis, Mo.) at 1:1 amine:lactone stoichiometry in methanol at 50° C. Upon completion of the reaction, the methanol is removed with rotary evaporation. The resulting material is a solid.

### b) A21-GL

DMS-A21 (Gelest Inc., Morrisville, Pa.), a 100-120 cst. telechelic polydimethylsiloxane endblocked with aminopropyl groups, is reacted with gluconolactone (GL) (Sigma-Aldrich, St. Louis, Mo.) at 1:1 amine:lactone stoichiometry in methanol at 50° C. Upon completion of the reaction, the methanol is removed with rotary evaporation. The resulting material is a wax-like solid.

### c) A32-GL

DMS-A32 (Gelest Inc., Morrisville, Pa.), a 2000 cst. telechelic polydimethylsiloxane endblocked with aminopropyl groups, is reacted with gluconolactone (GL) (Sigma-Aldrich, St. Louis, Mo.) at 1:1 amine:lactone stoichiometry in methanol at 50° C. Upon completion of the reaction, the methanol is removed with rotary evaporation. The resulting material has a gum-like consistency.

### d) 8175-GL

DC® Q2-8175 Fluid (Dow Corning Corp., Midland, Mich.), a 150-400 cst. polydimethylsiloxane with pendant aminoethylaminoisobutyl groups (approximately 2.3 mole percent), is reacted with gluconolactone at 1:1 primary amine:lactone stoichiometry in methanol at 50° C. Upon completion of the reaction, the methanol is removed with rotary evaporation. The resulting material has a gum-like consistency.

### e) 8211-GL

DC® 2-8211 Polymer (Dow Corning Corp., Midland, Mich.), a 1000 cst. polydimethylsiloxane with pendant aminoethylaminoisobutyl groups (approximately 1.9 mole percent), is reacted with gluconolactone at 1:1 primary amine:lactone stoichiometry in methanol at 50° C. Upon completion of the reaction, the methanol is removed with rotary evaporation. The resulting material has a gum-like consistency.

### f) 8175/A12-GL

DC® Q2-8175 Fluid (Dow Corning Corp., Midland, Mich.), a 150-400 cst. polydimethylsiloxane with pendant aminoethylaminoisobutyl groups (approximately 2.3 mole percent), and DMS-A12 are mixed together in a 1:1 by weight solution. This mixture is reacted with GL at a 1:1 primary amine:lactone stoichiometry in methanol at 50° C. Upon completion of the reaction, the methanol is removed with rotary evaporation. The resulting material has is a wax-like substance.

### g) A12-LBL

DMS-A12 (Gelest Inc., Morrisville, Pa.), a 20-30 cst. telechelic polydimethylsiloxane endblocked with aminopropyl groups, is reacted with lactobionolactone (LBL) (prepared from lactobionic acid, Sigma-Aldrich, St. Louis, Mo.) at 1:1 amine:lactone stoichiometry in methanol at 50° C. Upon completion of the reaction, the methanol is removed with rotary evaporation. The resulting material is a solid.

### h) A21-LBL

DMS-A21 (Gelest Inc., Morrisville, Pa.), a 100-320 cst. telechelic polydimethylsiloxane endblocked with aminopropyl groups, is reacted with lactobiolactone (LBL) (prepared from lactobionic acid, Sigma-Aldrich, St. Louis, Mo.) at 1:1 amine:lactone stoichiometry in methanol at 50° C. Upon completion of the reaction, the methanol is removed with rotary evaporation. The resulting material is wax-like.

### i) A32-LBL

DMS-A32 (Gelest Inc., Morrisville, Pa.), a 2000 cst. telechelic polydimethylsiloxane endblocked with aminopropyl groups, is reacted with lactobiolactone (LBL) (prepared from lactobionic acid, Sigma-Aldrich, St. Louis, Mo.) at 1:1 amine:lactone stoichiometry in methanol at 50° C. Upon completion of the reaction, the methanol is removed with rotary evaporation. The resulting material is wax-like.

### j) 8175-LBL

DC® Q2-8175 Fluid (Dow Corning Corp., Midland, Mich.), a 150-400 cst. polydimethylsiloxane with pendant aminoethylaminoisobutyl groups (approximately 2.3 mole percent), is reacted with lactobionolactone (LBL) (prepared from lactobionic acid, Sigma-Aldrich, St. Louis Mo.) at 1:1 primary amine:lactone stoichiometry in methanol at 50° C. Upon completion of the reaction, the methanol is removed with rotary evaporation. The resulting material is wax-like.

### k) 8211-LBL

DC® 2-8211 Polymer (Dow Corning Corp., Midland, Mich.), a 1000 cst. polydimethylsiloxane with pendant aminoethylaminoisobutyl groups (approximately 1.9 mole percent), is reacted with lactobionolactone (LBL) (prepared from lactobionic acid, Sigma-Aldrich, St. Louis Mo.) at 1:1 primary amine:lactone stoichiometry in methanol at 50° C. Upon completion of the reaction, the methanol is removed with rotary evaporation. The resulting material is a rubbery powder.

### l) 8175/A12-LBL

DC® Q2-8175 Fluid (Dow Corning Corp., Midland, Mich.), a 150-400 cst. polydimethylsiloxane with pendant aminoethylaminoisobutyl groups (approximately 2.3 mole percent), and DMS-A12 (Gelest Inc., Morrisville, Pa.), a 20-30 cst. telechelic polydimethylsiloxane endblocked with aminopropyl groups are mixed together in a 1:1 by weight solution. This mixture is reacted with LBL at 1:1 primary amine:lactone stoichiometry in methanol at 50° C. Upon completion of the reaction, the methanol is removed with rotary evaporation. The resulting material is wax-like.

### m) 8175-GL-GTMAC

8175-GL, prepared above, is diluted to 50% copolymer in 2-propanol. 194 g of this solution is loaded into a nitrogen purged, three-necked 500 mL round bottomed flask equipped with a condenser and temperature control and magnetic stirrer. 5.91 g of (2,3-epoxypropyl)-trimethylammonium chloride (Fluka, Buchs, Switerland) is added with stirring. The reaction is maintained at 50° C. for four hours. 50 g of a this solution is placed on a rotary evaporator and the solvent is removed until an 80% solid solution remains.

### n) 8175-GL-2X

DC® Q2-8175 Fluid (Dow Corning Corp., Midland, Mich.), a 150-400 cst. polydimethylsiloxane with pendant aminoethylaminoisobutyl groups (approximately 2.3 mole percent), is reacted with gluconolactone at 1:1 primary amine:lactone and a 1:1 secondary amine:lactone stoichiometry in methanol at 50° C. Upon completion of the reaction, the methanol is removed with rotary evaporation. The resulting material has a powder-like consistency.

### Example 2

### Preparation of Dispersions for Delivery of Saccharide-Siloxane Copolymer

This example illustrates dispersions, including solutions and emulsions, of the saccharide-siloxane copolymers prepared in Example 1. For many of the household care application embodiment examples disclosed below, delivery of the saccharide-siloxane copolymer is accomplished by dispersing the solid form of the copolymer in a carrier medium for ease of incorporation into final formulations. Where “saccharide-siloxane” is referenced, the material is being incorporated as a solution comprising 20% saccharide-siloxane solid by weight percent, rather than in solid form.

### (i) Preparation of Solutions

An aqueous solution is made by adding saccharide-siloxane solid and water in the weight percentages shown in Table 3 into a closed container which is then rolled until the solids are fully dissolved (approximately 2-4 hours). For non-aqueous dispersions, the saccharide-siloxane solid is added with cyclopentasiloxane to a closed loop vessel and heated to 70° using a constant temperature bath. Periodic agitation is applied to the dispersion by any number of methods (e.g. use of a lightening mixer, dental mixer, or similar high-shear device, rolling, shaking, and so on). The length of time required for complete incorporation into solution varies from 2-10 hours depending on the solubility of the particular saccharide-siloxane.

As illustrated by the data in Table 4, saccharide-siloxanes (both the LBL and GL forms) prove to be effective thickeners for cyclic siloxanes. Table 4 also lists the viscosity of the thickened cyclic dispersions where it is able to be measured.

The saccharide-siloxane dilutions may also be incorporated into formulations in the form of an emulsion. Emulsions are frequently employed because they are easier to incorporate into water based formulations due to their lower viscosity and ease of handling.

TABLE 3
Saccharide-siloxane Copolymer Dilutions

| | | Weight % | | |
|---|---|---|---|---|
| | | Saccharide | Weight % 245 | |
| Copolymer | | Sixolane | Fluid | Weight % Water |
| a. | A12-GL | 20.0 | | 80.0 |
| b. | A12 LBL | 20.0 | | 80.0 |
| c. | A21-GL | 20.0 | 80.0 | |
| d. | A21-LBL | 20.0 | 80.0 | |
| e. | A32-GL | 20.0 | 80.0 | |
| f. | 8175-GL | 20.0 | 80.0 | |
| g. | 8175-LBL | 20.0 | 80.0 | |
| h. | 8211 GL | 20.0 | 80.0 | |
| i. | 8211 LBL | 20.0 | 80.0 | |

TABLE 4
Physical Form of 20% Saccharide-Siloxane Dispersions

| Disperson | | |
|---|---|---|
| Containing | | |
| Saccharide-Siloxane | GL | LBL |
| A12 | Swollen Gel Particles | Opaque, Low Viscosity |
| | | (30 cP) Fluid |
| A21 | Opaque, High Viscosity | Translucent, High |
| | (100P) Fluid | Viscosity Gum |
| A32 | Clear, High Viscosity | Clear, High Viscosity |
| | (300P) Fluid | Gum |
| 8175 | Clear, Medium Viscosity | Translucent, High |
| | (50P) Fluid | Viscosity Gum |
| 8211 | Clear, High Viscosity | Swollen Gel Particles |
| | Gum | |

### (ii) Preparation of Emulsions

### j. 8175-GL-GTMAC Cationic Sugar Siloxane Emulsion w/ Nonionic Surfactant

22 g of a solution prepared according to Example 1m, 0.9 g of Tergitol 15-S-3 and 2.6 g of Tergitol 15-S-40 nonionic surfactants are placed in a disposable cup and mixed on a centrifugal mixer (Hauschild Speedmixer, Landrum S.C.). 1 g increments of water are added and mixed until a gel forms. 4-10 g increments of water are added and mixed to dilute the resultant emulsion. The final emulsion contains 24% copolymer. The particle size is measured using a Nicomp 370 (Particle Sizing Systems, Santa Barbara, Calif.). The volume weighted median particle size is 135 nanometers.

### k. 8175-GL-GTMAC Cationic Saccharide-siloxane Emulsion w/ Cationic Surfactant

50 g of a solution prepared according to Example 1m is placed on a rotary evaporator and the solvent removed until an 80% solid solution remains. 40 g of this solution, 2.5 g of 2-propanol, and 11.72 g of Arquad 16-29 cationic surfactant (Akzo Nobel, Amersfoort, the Netherlands) are placed in a disposable cup and mixed on a centrifugal mixer (Hauschild Speedmixer, Landrum S.C.). 2 g increments of water are added and mixed until a gel is formed. 4-5 g increments of water are added and mixed to dilute the resultant emulsion. The final emulsion contains 40% copolymer. The particle size is measured using a Nicomp 370(Particle Sizing Systems, Santa Barbara, Calif.). The volume-weighted median particle size is 211 nanometers.

l. A32-GL Saccharide-siloxane Emulsion w/ Cationic Surfactant

30 g of A32-GL sugar siloxane (described previously) is diluted with a 90/10 by weight solution of Isopar G (ExxonMobil Chemical) and 2-propanol until a 75% copolymer concentration is achieved. The dilution is accomplished by sequential additions of the solvent followed by mixing on a Hauschild Speedmixer™ centrifugal mixer (Flacktek, Inc. Landrum, S.C.) until homogenous. 1.6 g of Tergitol 15-S-3 (Dow Chemical Co., Midland, Mich.) is mixed into the saccharide-siloxane solution. 11.1 g of Arquad 16-29 (Akzo Nobel Surface Chemistry LLC, Chicago, Ill.) are then added and mixed until emulsified. Subsequent mixing is done until a clear gel forms. Additional water is added and mixed until a 50% internal phase concentration is achieved. The median volume particle size is 277 nm, measured with a Nicomp 370 (Particle Sizing Systems, Inc. Santa Barbara, Calif.).

m. A32-GL Sugar Siloxane Emulsion w/ Nonionic Surfactant

25 g of A32-GL sugar siloxane (described previously) is diluted with a 90/10 by weight solution of Isopar G (ExxonMobil Chemical) and 2-propanol until a 75% copolymer concentration is achieved. The dilution is accomplished by sequential additions of the solvent followed by mixing on a Hauschild Speedmixer™ centrifugal mixer (Flacktek, Inc. Landrum, S.C.) until homogenous. 1 g of Tergitol 15-S-3 (Dow Chemical Co., Midland, Mich.) is mixed into the saccharide-siloxane solution. 3 g of Tergitol 15-S-40 (70%) (Dow Chemical Co., Midland, Mich.) and 3 g of deionized water are then added and mixed until emulsified. Subsequent mixing is done until a clear gel forms. Additional water is added and mixed until a 40% internal phase concentration is achieved. The median volume particle size is 537 nm, measured with a Nicomp 370 (Particle Sizing Systems, Inc. Santa Barbara, Calif.).

n. A32-LBL Sugar Siloxane Emulsion w/ Nonionic Surfactant

2 g Tergitol 15-S-3 (Dow Chemical Co., Midland, Mich.) is mixed into 51 g of an A32-LBL saccharide-siloxane solution (44% saccharide-siloxane in 90/10 by weight Isopar G (ExxonMobil Chemical) and 2-propanol). 16.4 g of Tergitol 15-S-40 (70%) (Dow Chemical Co., Midland, Mich.) and 2.1 g of deionized water is then added and mixed until emulsified. Subsequent mixing continues until a clear gel forms. Additional water is added and mixed until a 45% internal phase concentration is achieved. The median volume particle size is 692 nm, measured with a Nicomp 370 (Particle Sizing Systems, Inc. Santa Barbara, Calif.).

o. A32-GL Sugar Siloxane Emulsion w/ Cationic Surfactant

15 g A32-GL, 30 g DC 245 and 2 g isopropanol are mixed for 4 hours with a magnetic stirrer. 15 g of this A32-GL/DC 245/isopropanol blend is added with 0.58 g of servamine KW 50 and mixed for 20 seconds in a dental mixer. 4 g of servamine KAC 458 is then added and mixed for 20 seconds. 9.2 g of water is added stepwise with 20 seconds mixing between each step. Finally, 0.1 g of Proxel BD20 is added and homogenized for 20 seconds.

p. A32-LBL Sugar Siloxane Emulsion w/ Cationic Surfactant

15 g A32-LBL, 30 g DC 245 and 2 g isopropanol are mixed for 4 hours with a magnetic stirrer. 15.36 g of this A32-LBL/DC 245/isopropanol blend is added with 0.58 g of servamine KW 50 and mixed for 20 seconds in a dental mixer. 4 g of servamine KAC 458 is then added and mixed for 20 seconds. 9 g of water is added stepwise with 20 seconds mixing between each step. Finally, 0.1 g of Proxel BD20 is added and homogenized for 20 seconds.

q. A21-LBL Sugar Siloxane Emulsion w/ Cationic Surfactant

15 g A21-LBL, 30 g DC 245 and 2 g isopropanol are mixed for 4 hours with a magnetic stirrer. 23.2 g of this A21-LBL/DC 245/isopropanol blend is added with 0.84 g of servamine KW 50 and mixed for 20 seconds in a dental mixer. 6.6 g of servamine KAC 458 is then added and mixed for 20 seconds. 14 g of water is added stepwise with 20 seconds mixing between each step. Finally, 0.1 g of Proxel BD20 is added and homogenized for 20 seconds.

### r. 8211-GL Sugar Siloxane Emulsion

8211-GL, prepared as in Example 1e, is diluted to a 50% solids solution using a 90/10 (wt./wt.) mixture of Isopar G (ExxonMobil Chemical) and 2-propanol. To 100 parts of this solution, 2.9 parts of Tergitol 15-S-3 (Dow Chemical Co., Midland, Mich.) 8.8 parts of Tergitol 15-S-40 (70%) as actives (Dow Chemical Co., Midland, Mich.) and 13 parts of deionized water are added and mixed until emulsified. Subsequent mixing continues until a clear gel forms. Additional water is added and mixed until a 50% internal phase concentration is achieved. The median volume particle size is 1.4 microns as measured with a Nicomp 370 (Particle Sizing Systems, Inc. Santa Barbara, Calif.).

### s. 8211-GL Sugar Siloxane Emulsion

8211-LBL, prepared as in Example 1k, is diluted to a 20% solids solution using a 90/10 (wt./wt.) mixture of Isopar G (ExxonMobil Chemical) and 2-propanol. To 100 parts of this solution, 2.8 parts of Tergitol 15-S-3 (Dow Chemical Co., Midland, Mich.) 7.1 parts of Tergitol 15-S-40 (70%) as actives (Dow Chemical Co., Midland, Mich.) and 5.1 parts of deionized water are added and mixed until emulsified. Subsequent mixing continues until a clear gel forms. Additional water is added and mixed until a 62% internal phase concentration is achieved. The median volume particle size is 158 microns as measured with a Nicomp 370 (Particle Sizing Systems, Inc. Santa Barbara, Calif.).

### t. 8175-GL Sugar Siloxane Emulsion

8175-GL, prepared as in Example 1d, is diluted to a 75% solids solution using a 90/10 (wt./wt.) mixture of Isopar G (ExxonMobil Chemical) and 2-propanol. To 100 parts of this solution, 2.9 parts of Tergitol 15-S-3 (Dow Chemical Co., Midland, Mich.) 6.3 parts of Tergitol 15-S-40 (70%) as actives (Dow Chemical Co., Midland, Mich.) and 7.9 parts of deionized water are added and mixed until emulsified. Subsequent mixing continues until a clear gel forms. Additional water is added and mixed until a 26.7% internal phase concentration is achieved. The median volume particle size is 556 microns as measured with a Nicomp 370 (Particle Sizing Systems, Inc. Santa Barbara, Calif.).

### u. 8175-GL-2X Sugar Siloxane Emulsion

8175-GL-2X, prepared as in Example in, is diluted to a 54.3% solids solution using a 90/10 (wt./wt.) mixture of Isopar G (ExxonMobil Chemical) and 2-propanol. To 100 parts of this solution, 3.0 parts of Tergitol 15-S-3 (Dow Chemical Co., Midland, Mich.) 6.2 parts of Tergitol 15-S-40 (70%) as actives (Dow Chemical Co., Midland, Mich.) and 8.0 parts of deionized water are added and mixed until emulsified. Subsequent mixing continues until a clear gel forms. Additional water is added and mixed until a 36.8% internal phase concentration is achieved. The median volume particle size is 405 microns as measured with a Nicomp 370 (Particle Sizing Systems, Inc. Santa Barbara, Calif.).

### v. 8175-GL-GTMAC Sugar Siloxane Emulsion

8175-GL-GTMAC, prepared as in Example 1m, with the exception of being 88% copolymer in 2-propanol (IPA). To 100 parts of this solution, 3.2 parts of Tergitol 15-S-3 (Dow Chemical Co., Midland, Mich.) 6.2 parts of Tergitol 15-S-40 (70%) as actives (Dow Chemical Co., Midland, Mich.) and 8.0 parts of deionized water are added and mixed until emulsified. Subsequent mixing continues until a clear gel forms. Additional water is added and mixed until a 22.7% internal phase concentration is achieved. The median volume particle size is 274 microns as measured with a Nicomp 370 (Particle Sizing Systems, Inc. Santa Barbara, Calif.).

TABLE 5
Saccharide-Siloxane Emulsion Characteristics

| Emulsion | Internal | Internal | Saccharide- | Surfactant | Median |
|---|---|---|---|---|---|
| ContainingSaccharide- | Phase | Phase | Siloxane | plus | Volume |
| Siloxane | Description | Concentration % | Concentration % | cosurf | PS nm |
| 8175-GL GTMAC | 80% | 29.4 | 23.5 | 15-S-40 | 135 |
| | copolymer | | | 15-S-3 | |
| | in IPA | | | | |
| A32-LBL | 44% | 45.3 | 20.0 | 15-S-40 | 692 |
| | copolymer | | | 15-S-3 | |
| | in 90/10 | | | | |
| | Isopar | | | | |
| | G/IPA | | | | |
| A32-GL | 75% | 40.0 | 30.0 | 15-S-40 | 537 |
| | copolymer | | | 15-S-3 | |
| | in 90/10 | | | | |
| | Isopar | | | | |
| | G/IPA | | | | |
| 8175-GL-GTMAC | 80% | 50.0 | 40.0 | Arquad | 211 |
| | copolymer | | | 16-29 | |
| | in IPA | | | | |
| A32-GL | 75% | 50.0 | 37.5 | Arquad | 277 |
| | copolymer | | | 16-29 | |
| | in 90/10 | | | 15-S-3 | |
| | Isopar | | | | |
| | G/IPA | | | | |
| 8211-GL | 50% | 50 | 25 | 15-S-40 | 1382 |
| | copolymer | | | 15-S-3 | |
| | in 90/10 | | | | |
| | Isopar | | | | |
| | G/IPA | | | | |
| 8211-LBL | 20% | 62 | 20 | 15-S-40 | 158 |
| | copolymer | | | 15-S-3 | |
| | in 90/10 | | | | |
| | Isopar | | | | |
| | G/IPA | | | | |
| 8175-GL | 75% | 26.7 | 20 | 15-S-40 | 556 |
| | copolymer | | | 15-S-3 | |
| | in 90/10 | | | | |
| | Isopar | | | | |
| | G/IPA | | | | |
| 8175-GL-2X | 54.3% | 36.8 | 20 | 15-S-40 | 405 |
| | copolymer | | | 15-S-3 | |
| | in 90/10 | | | | |
| | Isopar | | | | |
| | G/IPA | | | | |
| 8175-GL-GTMAC | 88% | 22.7 | 20 | 15-S-40 | 274 |
| | copolymer | | | 15-S-3 | |
| | in IPA | | | | |

### Example 3

### Wrinkle Resistance

This example evaluates fabric resistance to wrinkle formation as a function of fabric treatment. The conditions are designed to simulate real consumer garment wear wrinkling.

### 1) Methodology:

The principle behind the Wrinkle Test employed herein derives from NF G 07-125 norm or AATCC # 128-1999.

Cotton sheets are wrinkled in a standard way using the “empty cylinder method”. The method consists in introducing the fabric sheet inside the cylinder with a shaft and placing a 750 g weight load on the fabric for 1 minute. A 2.5 kg normalized cotton sheet (Krefeld ref. 10A) fabric load, including 4 series of 5 fabric swatches, is first washed at 40° C. under cycle 5A of norm ISO6630 (2000). The wash cycle is performed with hard water in a Wascator Fom 71 washing machine. The fabric treatment is delivered through the last rinse cycle from a fully formulated fabric conditioner composition based on 16% Tetranyl L1/90 TEA quaternary ammonium salt dosed at 35 g per rinse. After washing, the fabric samples are line-dried and ironed with a steam iron set on 3 dots (steam/cotton). The fabric samples are then conditioned in a controlled-humidity room at 20° C. and 65% R.H. for a minimum of 12 hours before they are subjected to wrinkling as per above.

Three panelists sort the fabric samples by degree of wrinkling by using a paired comparison protocol. Observation is done according to NF G 07-137-1. Based on “n” different responses, a binomial distribution with “n” repetitions is used to determine the least significant difference according to NF V 09-012. The results are expressed at 95% and 99% confidence levels.

### 2) Results:

A cationic emulsion of a A32-LBL dispersion is added to a 16% tetranyl L1/90* esterquat based fabric softener at a 1%, 3% and 5% levels and compared to the same fabric softener base dosed identically but without additives, all other test conditions are identical. The A32-LBL dispersion formulation comprises the following specs: A32-LBL: 15 g; DC 245 Fluid: 30 g; IPA: 2 g. The emulsion formulation of above dispersion comprise the following specs: A32-LBL dispersion: 15 g; Servamine KW50: 0.65 g; Servamine KAC 458: 4 g; Demineralised water: 8 g; Proxel BD 20: 0.1 g. The test results are provided in Table 6.

TABLE 6

| | | | Ref- | | |
|---|---|---|---|---|---|
| A32- | A32- | A32- | erence | Ex | Statistical |
| LBL@5% | LBL@3% | LBL@1% | Softener | Aequo | Significance |
| 26 | 30 | | | 4 | Undifferentiated |
| 9 | | 48 | | 3 | Different |
| | | | | | 99% confidence |
| 46 | | | 5 | 9 | Different 95% |
| | | | | | confidence |
| | 7 | 50 | | 3 | Different |
| | | | | | 99% confidence |
| | 49 | | 5 | 6 | Different |
| | | | | | 99% confidence |
| | | 57 | 2 | 1 | Different |
| | | | | | 99% confidence |

The 1% formulation is statistically superior to 3% and 5% formulations which are also statistically superior to the reference. The inventive wrinkle-resistance formulation demonstrates significant improvement when compared to a standard fabric softener treatment.

### Example 4

### Fast Drying Benefit

This example is designed to evaluate the ability of a specific fabric treatment to accelerate water drainage from fabrics during the last spinning cycle of a wash machine cycle.

### 1) Methodology:

A fabric pre-conditioning step is performed to remove silicone treatment made during manufacturing of fabrics and to be sure that loads are free of silicone before specific treatment.

12 little terry towels (30×50 cm) are pre-washed 4 times in following conditions:
Prewash 1: Miele W377 washing machine—long program—water hardness: 0° F.—20 g Dash powder—Temperature: 95° C.—Spin rate: 600 rpm;
Blank 1: Miele W377—long program—water hardness: 0° F.—No detergent —Temperature: 95° C.—Spin rate: 600 rpm;
Prewash 2: same conditions as prewash 1;
Blank 2: same conditions as blank 1;

After pre-washing, the towels are dried in a tumble drier.

The 12 dried towels are treated by addition and gentle mixing in of the saccharide-siloxane composition to a softener placed into a softener drawer of the washing machine. The mixture comprises 25 g softener (7.5% Quat)

The mixture is pumped into the washing drum with the water of the last rinse cycle.

The towels are subject to the following washing conditions:

Miele W377 washing machine

Water hardness: 0° F.

Temperature: 40° C.

Spin rate: 600 RPM

Detergent: 20 g Dash powder

The percent residual water in the fabric after the wash cycle is evaluated by weighing the load of fabrics before and after the wash cycle and calculating the percentage of residual water as follows:

$$\% Residual water = \frac{[ Wet laundry - Dry laundry ]}{Dry laundry} \times 100$$

### 2) Results

An emulsion of A21-LBL/DC 245/isopropanol was added to a fabric softener at 3% silicone content. This formulation was compared to the fabric softener alone, and to water. The formulations were applied during the wash cycle and water retention was measured. The weight of the wash load was measured after the application in the washing machine.

| | |
|---|---|
| water | 123.5 ± 2.7%, |
| fabric softener alone | 108.4 ± 3.5% |
| fabric softener + saccharide siloxane emulsion: | 98 ± 2.4% |

These values indicate that the addition of the saccharide-siloxane significantly enhanced drying.

### Example 5

### Softness Benefit

This example is designed to evaluate and compare the softness of dry fabrics (towels in particular) after a wash cycle.

### 1) Methodology:

The fabrics are pre-conditioned to remove silicone treatment made during manufacturing of fabrics and to be sure that loads are free of silicone before specific treatment with the inventive compound.

A load is made with 5 new pillow cases and 4 little terry towels (30×50 cm)=1.0 kg This load is washed 4 times in the following conditions:
Pre-wash 1: Miele W377—long program—water hardness: 0° F.—20 g Dash powder—Temperature: 95° C.—Spin rate: 600 rpm
Blank 1: Miele W377—long program—water hardness: 0° F.—No detergent—Temperature: 95° C.—Spin rate: 600 rpm
Pre-wash 2: same conditions that in pre-wash 1
Blank 2: same conditions that blank 1

Complete cycle of pre-conditioning is standardized using the same type of washing machine (W377). As a time saving measure, three loads may be pre-washed simultaneously in the same washing machine. The total load is then 3.0 kg and the quantity of powder is adjusted to 60 g. The fabric is treated in two or three treatments made in parallel in 2 or 3 different washing machines in the same time. There is always one-reference treatment and one or two test treatments. All fabrics from different treatments are line-dried at the same time at room temperature to control for temperature and relative humidity and permit standardized comparison.

The washing conditions are as follows:

Miele W377

Load: 5 pillow cases and 4 little terry towels (30×50 cm)=1 kg

Temperature: 40° C.

Spin rate: 600 RPM

Detergent: 20 g of Dash powder

Softener: 12 g of KAO's tetranyl L1/90 softener base@16% active plus the evaluation material at disclosed level.

Washing machines are cleaned after each treatment by performing a wash cycle at 95° C. without a load. In case of treatments with softener, the softener drawer is manually cleaned with water before running the wash cycle to clean the machine.

### Panel Test Evaluation Method:

The following questions are posed to 16 panelists. One terry towel is used for 4 panelists and afterward is replaced by another one.
“Which of the towels is the more soft?”
“If the first fabric is the reference and quoted 5 on a scale of 1 to 10 how would you rate (the) other(s), considering 10 means very soft and smooth?”

The comparative test is assumed to yield results having a binomial distribution and the least significant difference calculated at different confidence level is translated in following “easy-to-understand” rating

99% confidence level-> “++++”
95% confidence level-> “+++”
90% confidence level-> “++”
80% confidence level->“+”
60% confidence level-> “=”
<60% confidence level-> “−”

### 2) Results

The numerical results are analyzed in order to calculate the mean result and the significance of the result using a one-tail t-test.

1.5% of A32-LBL was added to a fabric softener and applied in the rinse. Out of 16, 15 panelists selected the sugar siloxane emulsion as the softer.

1.5% of A32-GL was added to a fabric softener and applied in the rinse. Out of 16, 14 panel lists selected the sugar siloxane emulsion as the softer.

### Example 6

### Tissue Treatment by Emulsions of Saccharide-Siloxanes

The two saccharide siloxane emulsions are prepared as described in Table 7. 1-ply Scott tissue is coated with these emulsions, at two coat weights, using a gravure coater at the conditions described in Table 8.

TABLE 7

| Sugar | | | Sugar | Median | | |
|---|---|---|---|---|---|---|
| Siloxane | IP | IP | Siloxane | Volume | Sur- | Co-sur- |
| Type | Description | Conc. | Conc. | PS | factant | factant |
| 8175-GL | 75% | 26.7 | 20 | 468 | 15-S-40 | 15-S-3 |
| | copolymer | | | | | |
| | in 90/10 | | | | | |
| | Isopar | | | | | |
| | G/IPA | | | | | |
| 8175-GL- | 80% | 25 | 20 | 295 | 15-S-40 | 15-S-3 |
| GTMAC | copolymer | | | | | |
| | in IPA | | | | | |

TABLE 8

| Sugar Siloxane | Coating coverage | Meter | Rewind Roll |
|---|---|---|---|
| Type | (g/m²) | Roll Setting | Setting |
| 8175-GL | 0.24 | 10 | 10 |
| 8175-GL | 0.11 | 5 | 10 |
| 8175-GL-GTMAC | 0.25 | 6 | 10 |
| 8175-GL-GTMAC | 0.11 | 3 | 10 |

A specified amount of tissue is placed in water and the time when complete wet out is reached is reported. The results, summarized in Table 9, below, show that 8175-GL-GTMAC could still wet out after aging at 50° C. indicating potential as a hydrophilic softener for tissue.

TABLE 9

| Sugar Siloxane | % | 3 wk RT wet out | 1 wk 50° C. wet out |
|---|---|---|---|
| Type | (Me₂SiO) | (sec) | (sec) |
| 8175-GL | 3.30% | 135 | 180 |
| 8175-GL | 1.26% | 6 | 180 |
| 8175-GL-GTMAC | 2.66% | 25 | 180 |
| 8175-GL-GTMAC | 0.91% | 3 | 25 |
| untreated | 0.00% | 1.6 | 1.4 |

### Example 7

### Tissue Treatment by Dispersions of Saccharide-Siloxanes

25% dispersions of saccharide siloxanes 8175-GL, 8175-GL-GTMAC and Dow Corning® 2-8175 in 50/50 IPA/Heptane are prepared. These solutions are coated onto 1-ply Scott tissue using a gravure coater. A specified amount of tissue is placed in water and the time when complete wet out is reached is reported. The results, summarized below in Table 10, show that 8175-GL-GTMAC could still wet out after aging at 50 C indicating potential as a hydrophilic softener for tissue. Both the 8175-GL and the 8175-GL-GTMAC are rated higher for softness than the Dow Corning® 2-8175 control.

TABLE 10

| Sugar | 3 wk RT wet | 1 wk 50 C. wet | Panel | GC Digestion |
|---|---|---|---|---|
| Siloxane Type | out | out | Softness | % Si |
| 8175-GL | 3.97 | 180+ | 26 | 0.83 |
| 8175-GL- | 3.86 | 55.6 | 20 | 1.21 |
| GTMAC | | | | |
| 8175 (control) | 69.29 | 180+ | 15 | 0.49 |

### Example 8

### Wood Stain Additive

The following example demonstrates that the hydrophobing properties are improved when a wood stain formulation contains either a saccharide siloxane copolymer or a saccharide siloxane copolymer and a boric acid crosslinker.

Two emulsions prepared as in Example 3r and 3s above are added to a wood stain formulation so that the resulting compositions would contain 3% saccharide siloxane. These are designated 8211-LBL and 8211-GL in Table 11, below. The same formulations are repeated, only this time in addition to the saccharide siloxane at 3%, boric acid is added at a level of 2 parts per 100 parts saccharide-siloxane. These are designated 8211-LBL XL and 8211-GL XL in Table 11 below. A fifth formulation is prepared using a commercial water-based wood water repellant, Dow Corning® 2-9034, an organisilicone emulsion of siloxane monomers, polymers and organic polymer.

The final wood stain formulation contain 3% of the active ingredients of 2-9034. Pine slats are coated with formulations and allowed to dry. The swellometer test is performed to determine percent water exclusion and percent water repellency. After testing, the samples are dried and then exposed for 500 hours to a cycle of 4 hours of 340 nm UV light at 50° C. followed by 4 hours of condensation at 60° C. The ability of the wood to bead water is then evaluated by observing 0.1 mL droplets of water placed on the substrate. Untreated wood slats do not bead. Table 11 summarizes the results.

TABLE 11

| | | | 500 hour QUV |
|---|---|---|---|
| | % WE | % WR | Water Beading |
| 8211-LBL | 75 | 71 | >20 min |
| 8211-LBI XL | 80 | 73 | >20 min |
| 8211-GL | 65 | 56 | >20 min |
| 2-9034 | 82 | 74 | >20 min |

These results demonstrate that the saccharide siloxanes are effective as wood water repellents and can match the performance of a premium wood water repellent by the presence of the boric acid crosslinker.

### Example 9

### Textile Treatment by Dispersions of Saccharide-Siloxanes

Selected saccharide siloxanes and benchmark siloxanes are dispersed into the indicated solvent at 10% solids. These solutions are padded onto cotton fabric at a 0.5% level and dried at 150° C. for 3 minutes. The results are summarized in Table 12.

TABLE 12

| | untreated | A | B | C | D | E | F | G | H |
|---|---|---|---|---|---|---|---|---|---|
| saccharide | | 8175- | 8211- | 8175/A12 | 8175- | 8211- | 8175/A12 | DC | DC |
| siloxane | | GL | GL | GL | LBL | LBL | LBL | 8600 | 2- |
| | | | | | | | | | 8040 |
| DC 345 | | | | | X | | | X | X |
| Fluid | | | | | | | | | |
| Heptane | | | X | | X | | X | X | |
| Hexane | | X | | X | | X | X | | |
| Absorbency, | 10.28 | >300 | >300 | — | >300 | — | 20 | 210 | >300 |
| sec. | | | | | | | | | |
| Water | 0 | 70 | 80 | — | 0 | — | 0 | 0 | 80 |
| Repellency | | | | | | | | | |
| Whiteness | 75.43 | 70.79 | 67.75 | — | 72.4 | — | 73.09 | 66.98 | 63.59 |
| Index | | | | | | | | | |
| Relative | | | | | | | | | |
| Hand | | | | | | | | | |
| Evaluator 1 | 1 | 4 | 5 | — | 4.5 | — | 3.5 | 2.5 | 3 |
| Evaluator 2 | 1 | 4.5 | 4 | — | 5 | — | 3.5 | 3 | 2.5 |
| Mean | 1 | 4.25 | 4.5 | — | 4.75 | — | 3.5 | 2.75 | 2.75 |
| Standard | 0 | 0.35 | 0.71 | — | 0.35 | — | 0.00 | 0.35 | 0.35 |
| Deviation | | | | | | | | | |

These results demonstrate selected improvements in hand, absorbency, water repellency and whiteness.

### Example 10

### Hard Surface Cleaner with Emulsion of Saccharide-Siloxanes

### Emulsion Preparation:

14.6 g A21-LBL, 49.5 g DC 245 and 2 g isopropanol are mixed for 4 hours with a magnetic stirrer. 23.08 g of this A21-LBL/DC 245/isopropanol blend is added with 0.82 g of servamine KW 50 and mixed for 20 seconds in a dental mixer. 6.57 g of servamine KAC 458 is then added and mixed for 20 seconds. 14.31 g of water is added stepwise with 20 seconds mixing between each step. Finally, 0.1 g of Proxel BD20 is added and homogenized for 20 seconds.

### Hard Surface Cleaner:

A hard surface cleaner was prepared by adding 8 g of A21-LBL emulsion to 40.3 g “CIF active gel” (commercial hard surface cleaner) and gently stirred for 5 minutes.

### Example 11

### Dishwashing Cleaner with Emulsion of Saccharide-Siloxanes

### Emulsion:

14.6 g A21-LBL, 49.5 g DC 245 and 2 g isopropanol are mixed for 4 hours with a magnetic stirrer. 23.08 g of this A21-LBL/DC 245/isopropanol blend is added with 0.82 g of servamine KW 50 and mixed for 20 seconds in a dental mixer. 6.57 g of servamine KAC 458 is then added and mixed for 20 seconds. 14.31 g of water is added stepwise with 20 seconds mixing between each step. Finally, 0.1 g of Proxel BD20 is added and homogenized for 20 seconds.

### Dishwashing

9.9 g of A21-LBL emulsion is added to 49.9 g “Sun Liquigel” (commercial dishwashing cleaner) and gently stir for 5 minutes.

### Example 12

### Treatment of Textiles with Saccharide-Siloxanes Emulsions

Cotton twill (khaki) and cotton/polyester fabric samples were treated by dip coating in a diluted emulsion bath containing 1% saccharide siloxane using selected emulsions described in Table 5. The A12-LBL sample was provided as a powder and dispersed directly into water. The samples were dried by two methods: air drying or heat set. Air dried samples were maintained at room temperature for 24 hours and then tested. Heat set samples were first exposed to 150° C. for 3 min followed by 24 hour air drying and then tested. The air dried and heat set samples were tested with and without a durability rinse. The durability rinse consisted of rinsing in a washer with agitation, at room temperature water, for 5 minutes, spin dried and then air dried for 24 hours. The treated samples were evaluated for water repellency (AATCC Test Method 22-2001), oil repellency (AATCC Test Method 118-1997), stain release (AATCC Test Method 130) and hand.

TABLE 13

| | Twill (khaki) | | | | Cotton/Polyester Blend | | | |
|---|---|---|---|---|---|---|---|---|
| | Water | Oil | Stain | | Water | Oil | Stain | |
| | Repellency | Repellency | Release | Hand | Repellency | Repellency | Release | Hand |
| 8175-GL-GTMAC | | | | | | | | |
| (w/ nonionic surfactant) | | | | | | | | |
| air dried | 30 | 0 | 4 | 1.5 | 0 | 1c | 2 | 2 |
| air+ durability rinse | 30 | 0 | 4 | 2 | 0 | 0 | 2 | 2 |
| heat set | 65 | 0 | 4 | 1.5 | 0 | 1c | 1 | 1.5 |
| heat set+ durability rinse | 80 | 0 | 4 | 2 | 0 | 0 | 2 | 2 |
| 8175-GL-GTMAC | | | | | | | | |
| (w/ cationic surfactant) | | | | | | | | |
| air dried | 40 | 0 | 4 | 1.5 | 0 | 1c | 1 | 2 |
| air+ durability rinse | 70 | 0 | 3 | 2 | 0 | 0 | 2 | 2 |
| heat set | 55 | 0 | 4 | 1.5 | 0 | 1c | 1 | 1.5 |
| heat set+ durability rinse | 75 | 0 | 4 | 2 | 20 | 0 | 2 | 2 |
| 8211-LBL | | | | | | | | |
| air dried | 20 | 0 | 3 | 1.5 | 0 | 1c | 1 | 2.5 |
| air+ durability rinse | 70 | 0 | 3 | 1.5 | 30 | 0 | 2 | 2 |
| heat set | 25 | 0 | 4 | 1.5 | 0 | 1c | 2 | 2 |
| heat set+ durability rinse | 65 | 0 | 3 | 1.5 | 45 | 0 | 2 | 2 |
| A12-LBL | | | | | | | | |
| air dried | 10 | 0 | 3 | 2.5 | 0 | 1c | 1 | 2 |
| air+ durability rinse | 0 | 0 | 3 | 2.5 | 0 | 1c | 2 | 2.5 |
| heat set | 0 | 0 | 3 | 2.5 | 0 | 1c | 2 | 2 |
| heat set+ durability rinse | 0 | 0 | 3 | 2.5 | 0 | 1c | 2 | 2.5 |
| A32-GL (w/ | | | | | | | | |
| nonionic surfactant) | | | | | | | | |
| air dried | 20 | 0 | 4 | 1.5 | 0 | 1c | 2 | 2 |
| air+ durability rinse | 50 | 0 | 3 | 2 | 0 | 1c | 2 | 2 |
| heat set | 0 | 0 | 4 | 1.5 | 0 | 1c | 2 | 2 |
| heat set+ durability rinse | 50 | 0 | 3 | 2 | 0 | 1c | 2 | 2 |

Water Repellency (70-80% minimum acceptable for stain release; 90-100% minimum fro stain repellency)
Oil Repellency (0 = fail, 8 = highest, industry standard for C8 fluorocarbon is 5-7 rating)
Stain Release (1 = Heavy stain, 5 = No stain)
Hand (1 = harsh: 5 = excellent softness; untreated fabric = 2 rating)

### Example 13

### Treatment of Textiles with Saccharide-Siloxanes Emulsions and Fluorocarbon Emulsions

Cotton twill (khaki) and cotton/polyester fabric samples were treated by dip coating in a diluted emulsion bath containing 1% saccharide siloxane and 1% Unidyne TG571, a C8 fluorcarbon. The saccharide-siloxane emulsions are described in Table 5. The samples were dried by two methods: air drying or heat set. Air dried samples were maintained at room temperature for 24 hours and then tested. Heat set samples were first exposed to 150 C for 3 min followed by 24 hour air drying and then tested. The air dried and heat set samples were tested with and without a durability rinse. The durability rinse consisted of rinsing in a washer with agitation, at room temperature water, for 5 minutes, spin dried and then air dried for 24 hours. The treated samples were evaluated for water repellency(AATCC Test Method 22-2001), oil repellency (AATCC Test Method 118-1997), stain release (AATCC Test Method 130), and hand.

TABLE 14

| | Twill (khaki) | | | | Cotton/Polyester Blend | | | |
|---|---|---|---|---|---|---|---|---|
| | Water | | Stain | | Water | Oil | Stain | |
| | Repellency | Oil Repellency | Release | Hand | Repellency | Repellency | Release | Hand |
| 8175-GL-GTMAC | | | | | | | | |
| (w/ nonionic surfactant) | | | | | | | | |
| air dried | 50 | 0, 1d | 2 | 2 | 0 | 0, 1d | 3 | 2.5 |
| air+ durability rinse | 70 | 0, 1d | 2 | 2 | 10 | 0, 1d | 3 | 2 |
| heat set | 100 | 5a, 6c | 2 | 2 | 100 | 6a, 7c | 3 | 2.5 |
| heat set+ durability rinse | 90 | 1c | 2 | 2 | 100 | 1b | 3 | 2 |
| 8175-GL-GTMAC | | | | | | | | |
| (w/ cationic surfactant) | | | | | | | | |
| air dried | 70 | 0, 1d | 2 | 2 | 0 | 0, 1d | 3 | 2.5 |
| air+ durability rinse | 70 | 0, 1d | 3 | 2 | 10 | 0, 1d | 3 | 2 |
| heat set | 90 | 5a, 6b | 2 | 2 | 90 | 1a, 2b | 4 | 2.5 |
| heat set+ durability rinse | 85 | 1c | 3 | 2 | 90 | 1c | 3 | 2 |
| 8211-LBL | | | | | | | | |
| air dried | 45 | 0, 1d | 3 | 2 | 0 | 0, 1d | 2 | 2.5 |
| air+ durability rinse | 60 | 0, 1d | 4 | 2 | 40 | 0, 1d | 2 | 2 |
| heat set | 90 | 3b, 4a | 4 | 2 | 85 | 2a, 3b | 2 | 2 |
| heat set+ durability rinse | 90 | 1c | 4 | 2 | 95 | 1c | 2 | 2 |
| A12-LBL | | | | | | | | |
| air dried | 0 | 1c | 4 | 2 | 0 | 1c | 2 | 2.5 |
| air+ durability rinse | 10 | 0, 1d | 4 | 2 | 0 | 1b, 2d | 2 | 2 |
| heat set | 85 | 5a, 6b | 4 | 2 | 40 | 5a, 6b | 2 | 2.5 |
| heat set+ durability rinse | 75 | 0, 1d | 4 | 2 | 40 | 1b, 2c | 2 | 2 |
| A32-GL | | | | | | | | |
| (w/ nonionic surfactant) | | | | | | | | |
| air dried | 50 | 0, 1d | 3 | 2 | 0 | 1c | 2 | 2.5 |
| air+ durability rinse | 60 | 0, 1d | 3 | 2 | 0 | 0, 1d | 3 | 2 |
| head set | 90 | 3a, 4b | 2 | 2 | 85 | 4a, 5b | 2 | 2.5 |
| heat set+ durability rinse | 80 | 0, 1d | 3 | 2 | 85 | 1c | 3 | 2 |

Water Repellency (70-80% minimum acceptable for stain release; 90-100% minimum fro stain repellency)
Oil Repellency (0 = full, 8 = highest, industry standard for C8 fluorocarbon is 5-7 rating)
Stain Release (1 = Heavy stain, 5 = No stain)
Hand (1 = harsh; 5 = excellent softness; untreated fabric = 2 rating)

### Example 14

### Treatment of Vinyl Surfaces with Saccharide-Siloxanes Emulsions

3″×4″ vinyl samples were sprayed with a saccharide siloxane emulsion diluted to 1% actives. The emulsions used are described in Table 5. The A12-LBL sample was provided as a powder and dispersed directly into water. The samples were air dried at ambient conditions overnight. The treated samples were evaluated for appearance, tackiness, relative gloss, and contact angle.

TABLE 15

| Saccharide- | | Relative | Water Contact |
|---|---|---|---|
| Siloxane | Appearance/Tactile | Gloss | Angle |
| 8175-GL-GTMAC | Pooled areas/no tack | 1 | |
| (w/nonioinic | | | |
| surfactant) | | | |
| 8175-GL GTMAC | fisheyes(ringlets)/no | 1 | |
| (w/cationic | tack | | |
| surfactant | | | |
| 8211-LBL | pooled, some | 2 | 86 |
| | shine/slight tack | | |
| A12-LBL | uniform film, some | 2 | 101 |
| | shine/smooth feel | | |
| Untreated Vinyl | | 1 | |
| 350 cst 200 fluid | | 5 | |

Shine rating scale: 1 = no shine; 5 = very shiny

### Example 15

### Treatment of Vinyl Surfaces with Saccharide-Siloxanes Solvent Dispersions

3″×4″ vinyl samples were sprayed with a saccharide siloxane dispersed in isopropanol at 1% actives. The samples were air dried at ambient conditions overnight. The treated samples were evaluated for appearance, tackiness, relative gloss, and contact angle.

TABLE 16

| Saccharide- | | Relative | Water Contact |
|---|---|---|---|
| Siloxane | Appearance/Tactile | Gloss | Angle |
| 8175-GL-GTMAC | Smooth feel, no tack, | 1 | 95.50 |
| | uniform film | | |
| 8175-GL | Smooth feel, no tack, | 1 | 103.67 |
| | uniform feel | | |
| 8211-LBL | Some pooling, very | 1 | 121.33 |
| | smooth feel, no tack | | |
| 8175-LBL | Very smooth feel, no | 1 | 105.50 |
| | tack, uniform film | | |
| 8211-GL | Smooth feel, no tack, | 1 | 114.50 |
| | uniform film | | |
| Untreated Vinyl | | 1 | |
| 350 cst 200 fluid | | 5 | |

Shine rating scale: 1 = no shine; 5 = very shiny

TABLE 17
AATCC Test Method 118-1997 for Oil Repellency:
Hydrocarbon Resistance Test

| AATCC Oil | |
|---|---|
| Repellency Grade Number | Composition |
| 0 | None (Fails Kaydol test) |
| 1 | Kaydol |
| 2 | 63:35 Kaydol: n-hexadecane by volume |
| 3 | n-hexadecane |
| 4 | n-tetradecane |
| 5 | n-dodecane |
| 6 | n-decane |
| 7 | n-octane |
| 8 | n-heptane |

### Example 16

### Treatment of Textiles with Saccharide-Siloxanes Emulsions

Interlock cotton Knit 460 and Beige Terry from Cognis fabric samples were treated by exhaustion for 45 minutes to leave 0.5% siloxane copolymer on the fabric using emulsions described in Table 5. The samples were dried by two methods: 1) the fabric was removed from the bottle and placed in the washer on Spin Cycle for 4 minutes, removed from the washer and placed in a dryer on Cotton Knit Cycle for 1 hour, 2) after drying by the first method, the fabric was exposed to 160° C. for 10 minutes. The treated samples were evaluated for absorbency, whiteness and hand. The results indicate that superior hand can be achieved with sugar siloxanes with only slight reductions in absorbancy vs. a benchmark material.

TABLE 18

| | | Absorbency, after | | | |
|---|---|---|---|---|---|
| | Absorbency, | yellowing at | Whiteness | Whiteness index, | |
| | after drying | 160° C./10 min | index after | after yellowing at | Hand |
| Sample | (seconds) | (seconds) | drying* | 160° C./10 min | Rating |
| DI Water | Instant | N.A. | 82.87 | 72.93 | 1 |
| DC 8600 | 2.2 | >601 | 81.65 | 73.33 | 4.25 |
| Hydriohilic | | | | | |
| Softner | | | | | |
| 8175-GL | 11.5 | N.A. | 83.30 | 60.7 | 4 |
| Emulsion | | | | | |
| 8175-GL- | 6.9 | N.A. | 82.70 | 66.9 | 5 |
| GTMAC | | | | | |
| 8175-GL-2X | 3.9 | N.A. | 83.20 | 58.5 | 4.5 |

1-58. (canceled)

59. A surface treatment composition comprising:
at least one saccharide-siloxane copolymer having a saccharide component and an organosiloxane component and linked by a linking group, wherein the saccharide-siloxane copolymer has the following formula:
R²ₐR¹₍₃₋ₐ₎SiO—[(SiR²R¹O)ₘ—(SiR¹₂O)ₙ]_{y}—SiR¹₍₃₋ₐ₎R²ₐ
wherein each R¹ can be the same or different and comprises hydrogen, C₁-C₁₂ alkyl, an organic radical, or R³-Q,
Q comprises an epoxy, cycloepoxy, primary or secondary amino, ethylenediamine, carboxy, halogen, vinyl, allyl, anhydride, or mercapto functionality,
m and n are integers from 0 to 10,000 and may be the same or different,
each a is independently 0, 1, 2, or 3,
y is an integer such that the copolymer has a molecular weight less than 1 million,
R² has the formula Z-(G¹)_{b}-(G²)_{c}, and there is at least one R² per copolymer,
wherein G¹ is a saccharide component comprising 5 to 12 carbons,
b+c is 1-10, b or c can be 0,
G² is a saccharide component comprising 5 to 12 carbons additionally substituted with organic or organosilicon radicals,
Z is the linking group and is independently selected from the group consisting of:
R³—NHC(O)—R⁴—;
R³—NHC(O)O—R⁴—;
R³—NH—C(O)—NH—R⁴—;
R³—C(O)—O—R⁴—;
R³—O—R⁴—;
R³—CH(OH)—CH₂—O—R⁴—;
R³—S—R⁴
R³—CH(OH)—CH₂—NH—R⁴—; and
R³—N(R¹)—R⁴, and
R³ and R⁴ are divalent spacer groups comprising (R⁵)ᵣ(R⁶)ₛ(R⁷)ₜ,
where at least one of r, s and t must be 1, and
R⁵ and R⁷ are either C₁-C₁₂ alkyl or ((C₁-C₁₂)O)ₚ where p is any integer 1-50 and each (C₁-C₁₂)O may be the same or different,
R⁶ is —N(R⁸)—, where R⁸ is H or C₁-C₁₂ alkyl, or is Z-X where Z is previously defined or R³,
X is a carboxylic acid, phosphate, sulfate, sulfonate or quaternary ammonium radical, and at least one of R³ and R⁴ must be present in the linking group and may be the same or different, and
wherein the saccharide-siloxane copolymer is a reaction product of a functionalized organosiloxane polymer and at least one hydroxy-functional saccharide such that the organosiloxane component is covalently linked via the linking group, Z, to the saccharide component.

60. The surface treatment composition as recited in claim 59, further comprising a surfactant, wherein the surfactant is present at a concentration of from about 0.05% to about 99%, by weight of the composition; said surfactant being selected from the group consisting of nonionic surfactant; anionic surfactant; cationic surfactant; amphoteric surfactant; and mixtures thereof.

61. The surface treatment composition as recited in claim 59 further comprising at least one adjunct ingredient selected from the group consisting of bleaches, emulsifiers, fabric softeners, perfumes, antibacterial agents, antistatic agents, brighteners, dye fixative agents, dye abrasion inhibitors, anti-crocking agents, wrinkle reduction agents, wrinkle resistance agents, shape retention agents, soil release agents, sunscreen agents, anti-fade agents, waterproofing agents, drying agents, stain-proofing agents, soil repelling agents, odor control agents, foam control agents, insect-repelling agents, enzymes, protective agents, anti-corrosive agents, detersive agents, builders, structurants, thickeners, pigments or dyes, viscosity modifiers, pH control agents, propellants and combinations thereof.

62. The surface treatment composition as recited in claim 59 further comprising at least one carrier medium comprising a carrier selected from the group consisting of solvent, water, propellant, solids, woven fibrous substrates, and non-woven fibrous substrates.

63. The surface treatment composition as recited in claim 59 wherein the at least one hydroxy-functional saccharide comprises an aldonic acid or an oligoaldonic acid.

64. The surface treatment composition as recited in claim 63 wherein the aldonic acid or the oligoaldonic acid comprises a lactone.

65. The surface treatment composition as recited in claim 64 wherein the lactone comprises gluconolactone or lactobionolactone.

66. The surface treatment composition as recited in claim 59 wherein the functionalized organosiloxane polymer comprises a polydimethylsiloxane.

67. The surface treatment composition as recited in claim 59 wherein the linking group comprises an amide, an amino, a urethane, a urea, an ester, an ether, a thioether, or an acetyl functional linking group.

68. The surface treatment composition as recited in claim 59 wherein the linking group comprises an amino functional linking group.

69. The surface treatment composition as recited in claim 68 wherein the amino functional linking group comprises aminopropyl or aminoethylaminoisobutyl functional groups.

70. The surface treatment composition as recited in claim 59 in the form of a dispersion of the saccharide-siloxane copolymer in a solvent.

71. The surface treatment composition as recited in claim 70 wherein the solvent comprises a substantially nonaqueous solvent.

72. The surface treatment composition as recited in claim 71 wherein the substantially nonaqueous solvent comprises a volatile silicone.

73. The surface treatment composition as recited in claim 72 wherein the volatile silicone comprises a cyclic siloxane.

74. The surface treatment composition as recited in claim 70 wherein the dispersion comprises from about 0.1% to about 50% saccharide-siloxane by weight percent of the dispersion and from about 0.01% to about 25% saccharide-siloxane by weight percent of the composition.

75. The surface treatment composition as recited in claim 70 wherein the dispersion is in the form of an emulsion and further comprises at least one surfactant and water.

76. The surface treatment composition as recited in claim 75 wherein the surfactant comprises a cationic surfactant.

77. The surface treatment composition as recited in claim 75 wherein the emulsion comprises from about 1% to about 95% saccharide-siloxane by weight percent of the emulsion and from about 0.01% to about 25% saccharide-siloxane by weight percent of the composition.

78. A method of preventing or reducing wrinkles on fabric comprising applying an effective amount of the composition as recited in claim 59 onto the surface of the fabric.

79. A method of providing a fabric softening and/or anti-wrinkling benefit to fabrics during a laundry cycle, wherein the laundry cycle may be a washing, a rinsing, or a drying cycle, the method comprising the steps of: (a) contacting the fabric, during the laundry cycle, with the surface treatment composition as recited in claim 59.
